(19) United States
(12) Patent Application Publication
(10) Pub. No.: US 2007/0139318 A1
(43) Pub. Date: Jun. 21, 2007

(54) Light emitting device and method of driving the same

(75) Inventor: Ji Hun Kim, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/508,933

(22) Filed: Aug. 24, 2006

(30) Foreign Application Priority Data
Dec. 21, 2005 (KR) 10-2005-0127074
Dec. 21, 2005 (KR) 10-2005-0127077
Dec. 21, 2005 (KR) 10-2005-0127087

(51) Int. Cl. G09G 3/32

(52) U.S. Cl. 345/82

(57) ABSTRACT

The present invention relates to a light emitting device where a cross-talk phenomenon is not occurred. The light emitting device according to a first embodiment of the present invention includes data lines, scan lines, pixels and discharging circuit. The data lines are disposed in a first direction. The scan lines are disposed in a second direction different. The pixels are formed in cross areas of the data lines and the scan lines. The discharging circuit discharges a first pixel of the pixels up to a first discharge voltage during a first discharge period of time, and discharges a second pixel of the pixels up to a second discharge voltage during a second discharge period of time. Here, the second discharge voltage is different from the first discharge voltage. The discharge voltages are changed in accordance with cathode voltages, and thus cross-talk phenomenon is not occurred in the light emitting device.

### CROSS-REFERENCE TO RELATED APPLICATIONS

This application claims priority from Korean Patent Application No. 2005-127074, No. 2005-127077, No. 2005-127087, filed on Dec. 21, 2005, the contents of which are incorporated herein by reference in their entirety.

### BACKGROUND OF THE INVENTION

1. Field of the Invention

The present invention relates to a light emitting device and a method of driving the same. More particularly, the present invention relates to a light emitting device where a cross-talk phenomenon is not occurred and a method of driving the same.

2. Description of the Related Art

A light emitting device emits a light having a certain wavelength when certain voltage or current is provided thereto, and especially an organic electroluminescent device is self light emitting device.

FIG. 1 is a block diagram illustrating a common light emitting device.

In FIG. 1, the light emitting device includes a panel 100, a controller 102, a first scan driving circuit 104, a second scan driving circuit 106, a discharging circuit 108, a precharging circuit 110 and a data driving circuit 112.

The panel 100 includes a plurality of pixels E11 to E44 formed in cross areas of data lines D1 to D4 and scan lines S1 to S4.

The controller 102 receives display data from an outside apparatus (not shown), and controls the scan driving circuits 104 and 106, the discharging circuit 108, the precharging circuit 110 and the data driving circuit 112 by using the received display data.

The first scan driving circuit 104 transmits first scan signals to some of the scan lines S1 to S4, e.g. S1 and S3. The second scan driving circuit 106 transmits second scan signals to other scan lines S2 and S4. As a result, the scan lines S1 to S4 are connected in sequence to a ground.

The discharging circuit 108 is connected to the data lines D1 to D4 through switches SW1 to SW4. In addition, the discharging circuit 108 turns on the switches SW1 to SW4 when discharging, and so the data lines D1 to D4 are connected to a zener diode ZD. As a result, the data lines D1 to D4 is discharged up to a zener voltage of the zener diode ZD.

The precharging circuit 110 provides precharge current corresponding to the display data to the discharged data lines D1 to D4 in accordance with control of the controller 102.

The data driving circuit 112 provides data currents corresponding to the display data to the precharged data lines D1 to D4 under control of the controller 102. As a result, the pixels E11 to E44 emit light.

FIG. 2A and FIG. 2B are views illustrating schematically the light emitting device of FIG. 1. FIG. 2C and FIG. 2D are timing diagrams illustrating a process of driving the light emitting device.

Hereinafter, the process of driving the light emitting device will be described after describing cathode voltages VC11 to VC41 corresponding to a first scan line S1.

As shown in FIG. 2A, a resistor between a pixel E11 and the ground is Rs, and a resistor between a pixel E21 and the ground is Rs+Rp. In addition, a resistor between a pixel E31 and the ground is Rs+2Rp, and a resistor between a pixel E41 and the ground is Rs+3Rp.

Here, it is assumed that the data currents I11 to I41 having the same magnitude are provided to the data lines D1 to D4 so that the pixels E11 to E41 emit light having the same brightness.

In this case, the data currents I11 to I41 pass to the ground through corresponding pixels E11 to E41 and the first scan line S1. Accordingly, since the data currents I11 to I41 have the same magnitude, cathode voltages VC11 to VC41 of the pixels E11 to E41 are proportioned to resistor between corresponding pixel and the ground. Hence, the values are high in the order of the cathode voltages VC41, VC31, VC21 and VC11.

In FIG. 2B, a resistor between a pixel E12 and the ground is Rs+3Rp, and thus is higher than that between the pixel E11 and the ground. Here, it is assumed that the data current I11 passing through the first data line D1 when the first scan line S1 is connected to the ground is identical to data current I12 passing through the first data line D1 when a second scan line S2 is connected to the ground. In this case, because cathode voltages VC11 and VC12 of the pixels E11 and E12 are proportioned to corresponding resistor, the cathode voltage VC12 is higher than the cathode voltage VC11.

Hereinafter, a process of driving the light emitting device will be described in detail.

The switches SW1 to SW4 are turned on, and the scan lines S1 to S4 are connected to a non-luminescent source having the same magnitude (V2) as a driving voltage of the light emitting device, e.g. voltage corresponding to maximum brightness of data current. Accordingly, the pixels E11 to E44 does not emit light, and the data lines D1 to D4 are discharged to the zener voltage of the zener diode ZD during a first discharge period of time (dcha1).

Subsequently, the switches SW1 to SW6 are turned off.

Then, precharge current corresponding to first display data is provided to the data lines D1 to D4 during a first precharge period of time (pcha1) as shown in FIG. 2C and FIG. 2D.

Subsequently, the first scan line S1 is connected to the ground as shown in FIG. 2A, and the other scan lines S2 to S4 are connected to the non-luminescent source.

Then, the data currents I11 to I41 corresponding to the first display data are provided to the data lines D1 to D4 during a first luminescent period of time (t1) as shown in FIG. 2C and FIG. 2D. As a result, the pixels E11 to E41 emit light during the first luminescent period of time (t1).

Hereinafter, the pixel E41 is assumed to have the same brightness as the pixel E11. That is, the data currents I11 and I41 having the same magnitude are provided to the data lines D1 and D4 during the first luminescent period of time (t1).

First, the data lines D1 and D4 are discharged up to the same discharge voltage during the first discharge period of time (dcha1) when discharging as shown in FIG. 2D, and so the data lines D1 and D4 are precharged to the same precharge level, i.e. certain precharge voltage during a first precharge period of time (pcha1).

Subsequently, the data currents I11 and I41 having the same magnitude are provided to the data lines D1 and D4, respectively. In this case, since the pixels E11 and E41 are preset to emit light having the same brightness, anode voltages VA11 and VA41 of the pixels E11 and E41 rise from the precharge voltage to a voltage which is different from corresponding cathode voltages VC11 and VC41 by a certain level, and then the voltages VA11 and VA41 are saturated. This is because a pixel emits a light having brightness corresponding to difference of its anode voltage and its cathode voltage.

For example, in case that the cathode voltage VC11 of the pixel E11 and the cathode voltage VC41 of the pixel E41 are 1V and 2V, respectively, the anode voltage V41 of the pixel E41 is saturated with 7V when the anode voltage VA11 of the pixel E11 is saturated with 6V. In this case, because the data lines D1 and D4 are precharged up to the same precharge voltage, e.g. 3V, the anode voltage VA11 of the pixel E11 is saturated with 6V after rising from 3V up to 6V. Whereas, the anode voltage VA61 of the pixel E61 is saturated with 7V after rising 3V up to 7V. Hence, charge amount consumed until the anode voltage VA41 of the pixel E41 is saturated is higher than that consumed until the anode voltage VA11 of the pixel E11 is saturated. Accordingly, though the pixels E11 and E41 are preset to have the same brightness, the pixel E41 emits a light having brightness smaller than the pixel E11.

Hereinafter, the process of driving the light emitting device will be described continuously.

The scan lines D1 to D4 are connected to the non-luminescent source, and the switches SW1 to SW4 are turned on. As a result, the data lines D1 to D4 is discharged up to a certain discharge voltage during a second discharge period of time (dcha2) as shown in FIG. 2C.

Subsequently, the switches SW1 to SW4 are turned off, and then precharge current corresponding to second display data is provided to the data lines D1 to D4. Here, the second display data is inputted to the controller 102 after the first display data is provided to the controller 102.

Then, the second scan line S2 is connected to the ground, and the other scan lines S1, S3 and S4 are connected to the non-luminescent source.

Subsequently, data currents I12 to I42 corresponding to the second display data are provided to the data lines D1 to D4 as shown in FIG. 2B, and so pixels E12 to E42 emit light during a second luminescent period of time (t2).

Hereinafter, the pixel E12 is preset to have the same brightness as the pixel E11.

In this case, because the resistor between the pixel E12 and the ground is higher than the resistor between the pixel E11 and the ground, the cathode voltage VC12 of the pixel E12 is higher than the cathode voltage VC11 of the pixel E11. Hence, charge amount consumed until the anode voltage VA12 of the pixel E12 is saturated is higher than that consumed until the anode voltage VA11 of the pixel E11 is saturated. Accordingly, the pixel E12 emits a light having brightness smaller than the pixel E11. This phenomenon that pixels preset to have the same brightness emit really light having different brightness is referred to as “cross-talk phenomenon”.

### SUMMARY OF THE INVENTION

It is a feature of the present invention to provide a light emitting device where cross-talk phenomenon is not occurred.

A light emitting device according to a first embodiment of the present invention includes data lines, scan lines, pixels and discharging circuit. The data lines are disposed in a first direction. The scan lines are disposed in a second direction different from the first direction. The pixels are formed in cross areas of the data lines and the scan lines. The discharging circuit discharges a first pixel of the pixels up to a first discharge voltage during a first discharge period of time, and discharges a second pixel of the pixels up to a second discharge voltage during a second discharge period of time. Here, the second discharge voltage is different from the first discharge voltage.

A light emitting device according to a second embodiment of the present invention includes data lines, scan lines, pixels and a discharging circuit. The data lines are disposed in a first direction. The scan lines are disposed in a second direction different from the first direction. The pixels are formed in cross areas of the data lines and the scan lines. The discharging circuit has at least one discharge assisting device, and discharges at least one data line to a discharge voltage corresponding to cathode voltage of pixel related to the data line. Here, the discharge assisting device facilitates the discharging.

A light emitting device according to a third embodiment of the present invention includes data lines, scan lines, pixels and discharging circuit. The data lines are disposed in a first direction. The scan lines are disposed in a second direction different from the first direction. The pixels are formed in cross areas of the data lines and the scan lines. The discharging circuit discharges at least one data line to a first discharge voltage during a first sub-discharge time of a discharge time, and discharges the discharge data line to a second discharge voltage corresponding to cathode voltage of pixel related to the data line during a second sub-discharge time of the discharge time. Here, the second sub-discharge time is changed depending on the magnitude of the second discharge voltage.

A method of driving a light emitting device having a plurality of pixels formed in cross areas of data lines and scan lines according to a first embodiment of the present invention includes providing a first voltage to a first outmost data line of outmost data lines of the data lines; and providing a second voltage to a second outmost data line of the outmost data lines. Here, at least one data line is discharged to a discharge voltage corresponding to a cathode voltage of pixel related to the data line and capacitance of a capacitor related to the pixel in accordance with the provided voltages. The method further includes discharging the data lines to a certain discharge voltage. The step of providing the first voltage includes: outputting a first level voltage in accordance with a first outside voltage inputted from an outside apparatus; and providing a certain voltage to the first outmost data line in accordance with the outputted first level voltage so that the first outmost data line has the first voltage. The step of providing the second voltage includes: outputting a second level voltage in accordance with a second outside voltage inputted from an outside apparatus; and providing a certain voltage to the second outmost data line in accordance with the outputted second level voltage so that the second outmost data line has the second voltage. The second voltage may have magnitude different from the first voltage.

A method of driving a light emitting device having a plurality of pixels formed in cross areas of data lines and scan lines according to a second embodiment of the present invention includes discharging a first data line corresponding to a first pixel of the data lines during a first discharge time; discharging a second data line corresponding to a second pixel of the data lines during a second discharge time; providing a first data current to the discharged first data line; and providing a second data current to the discharged second data line. Here, difference of voltage at endpoint of the first discharge time in waveform of voltage which the first data line has and voltage at endpoint of the second discharge time in waveform of voltage which the second data has corresponds to difference of cathode voltages of the pixels and difference of capacitances of capacitors related to the pixels.

A method of driving a light emitting device having a plurality of pixels formed in cross areas of data lines and scan lines according to a third embodiment of the present invention includes providing a first voltage to a first outmost data line of outmost data lines of the data lines; and providing a second voltage to a second outmost data line of the outmost data lines. Here, at least one data line is discharge to a discharge voltage corresponding to cathode voltage of pixel related to the data line, and the discharging is facilitated by discharge assisting device coupled to the data line. The discharge assisting device may be OP amp.

A method of driving a light emitting device having a plurality of pixels formed in cross areas of data lines and scan lines according to a fourth embodiment of the present invention includes discharging a first data line corresponding to a first pixel of the data lines during a first discharge time; discharging a second data line corresponding to a second pixel of the data lines during a second discharge time; providing a first data current to the discharged first data line; and providing a second data current to the discharged second data line. Here, difference of voltage at endpoint of the first discharge time in waveform of voltage which the first data line has and voltage at endpoint of the second discharge time in waveform of voltage which the second data has corresponds to difference of cathode voltages of the pixels, and the discharging is facilitated by discharge assisting device.

A method of driving a light emitting device having a plurality of pixels formed in cross areas of data lines and scan lines according to a fifth embodiment of the present invention includes discharging at least one data line to a first discharge voltage during a first sub-discharge time of a discharge time; and discharging the discharged data line to a second discharge voltage corresponding to cathode voltage of pixel related to the data line during a second sub-discharge time of the discharge time. Here, the second sub-discharge time is changed depending on magnitude of the second discharge voltage. The step of discharging the discharge data line to the second discharge voltage includes: providing a first voltage to a first outmost data line of outmost data lines of the data lines; and providing a second voltage to a second outmost data line of the outmost data lines. The second voltage may have magnitude different from the first voltage.

A method of driving a light emitting device having a plurality of pixels formed in cross areas of data lines and scan lines according to a sixth embodiment of the present invention includes discharging a first data line corresponding to a first pixel of the data lines and a second data line corresponding to a second pixel of the data lines to a first discharge voltage during a first sub-discharge time; discharging the discharged first data line to a second discharge voltage during a second sub-discharge time; and discharging the discharged second data line to a third discharge voltage during a third sub-discharge time. Here, difference of voltage at endpoint of the second sub-discharge time in waveform of voltage which the first data line has and voltage at endpoint of the third sub-discharge time in waveform of voltage which the second data has corresponds to difference of cathode voltages of the pixels, and the second sub-discharge time is changed depending on magnitude of the second discharge voltage.

As described above, in a light emitting device and a method of driving the same of the present invention, since a discharge voltage is adjusted in accordance with corresponding scan line resistor and capacitance of capacitor related to corresponding pixel, a cross-talk phenomenon is not occurred in the light emitting device.

In addition, in a light emitting device and a method of driving the same of the present invention, discharge voltages are changed in accordance with cathode voltages, and thus a cross-talk phenomenon is not occurred in the light emitting device.

Further, in a light emitting device and a method of driving the same of the present invention, a resistor Rd between data lines is increased, and so power consumption of the light emitting device is reduced.

Moreover, in a light emitting device and a method of driving the same of the present invention, because resistors having different resistances are selectively coupled to OP amplifier during a sub-discharge period of time, a second discharge period of time is optimized.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a block diagram illustrating a common light emitting device;

FIG. 2A and FIG. 2B are views illustrating schematically a light emitting device of FIG. 1;

FIG. 2C and FIG. 2D are timing diagrams illustrating a process of driving the light emitting device;

FIG. 3 is a block diagram illustrating a light emitting device according to a first embodiment of the present invention;

FIG. 4A and FIG. 4B are views illustrating schematically circuitries of the light emitting device in FIG. 3;

FIG. 4C and FIG. 4D are timing diagrams illustrating a process of driving the light emitting device;

FIG. 5 is a view illustrating circuitry of a light emitting device according to a second embodiment of the present invention;

FIG. 6 is a view illustrating a light emitting device according to a third embodiment of the present invention;

FIG. 7 is a view illustrating circuitry of the light emitting device in FIG. 6

FIG. 8 is a view illustrating a light emitting device according to a fourth embodiment of the present invention;

FIG. 9 is a view illustrating a light emitting device according to a fifth embodiment of the present invention;

FIG. 10A and FIG. 10B are views illustrating schematically circuitries of the light emitting device in FIG. 9;

FIG. 11 is a view illustrating circuitry of a light emitting device according to a sixth embodiment of the present invention;

FIG. 12 is a view illustrating a light emitting device according to a seventh embodiment of the present invention;

FIG. 13 is a view illustrating a light emitting device according to an eighth embodiment of the present invention;

FIG. 14A and FIG. 14B are views illustrating schematically circuitries of the light emitting device in FIG. 13;

FIG. 15 is a view illustrating a light emitting device according to a ninth embodiment of the present invention; and

FIG. 16 is a view illustrating a light emitting device according to a tenth embodiment of the present invention.

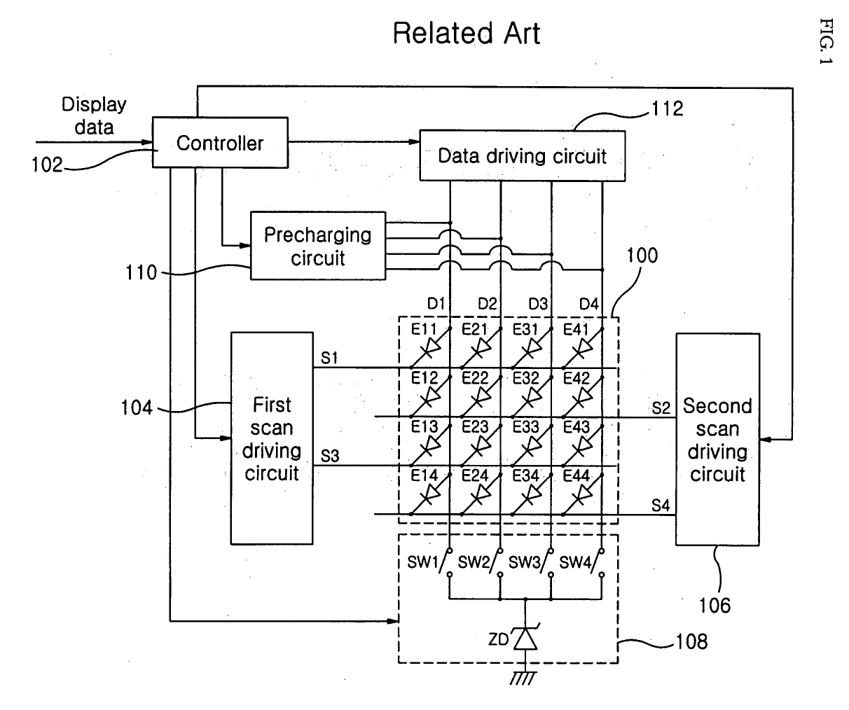

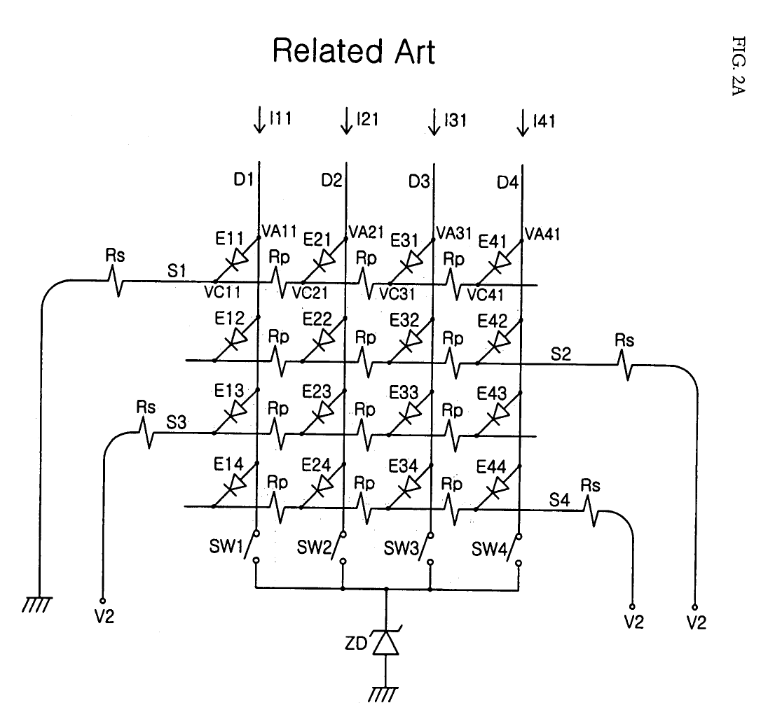

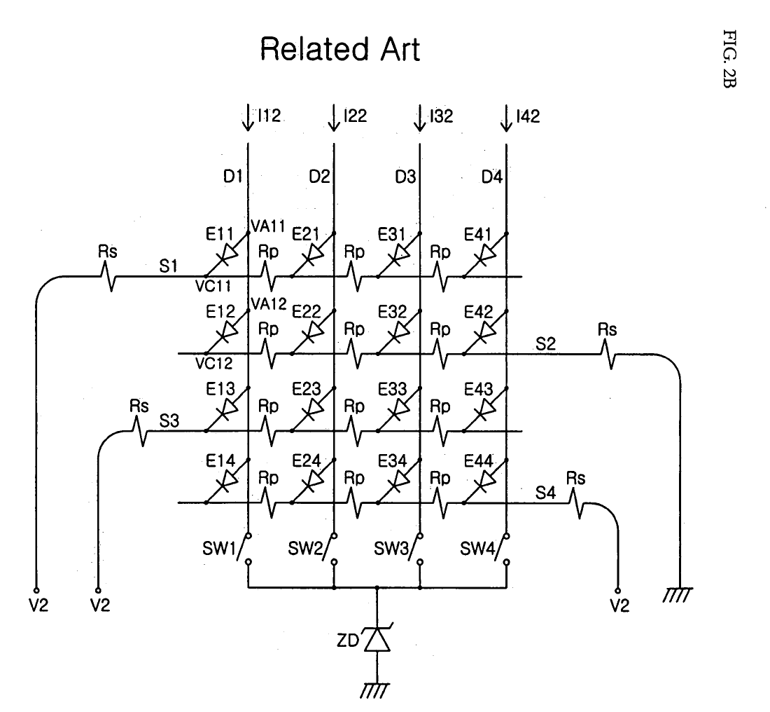

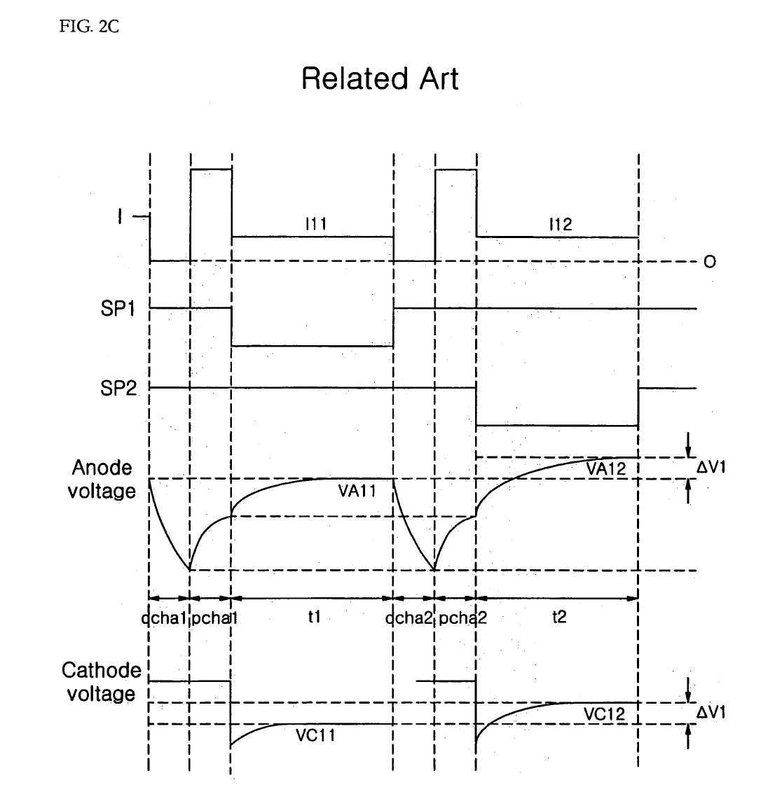

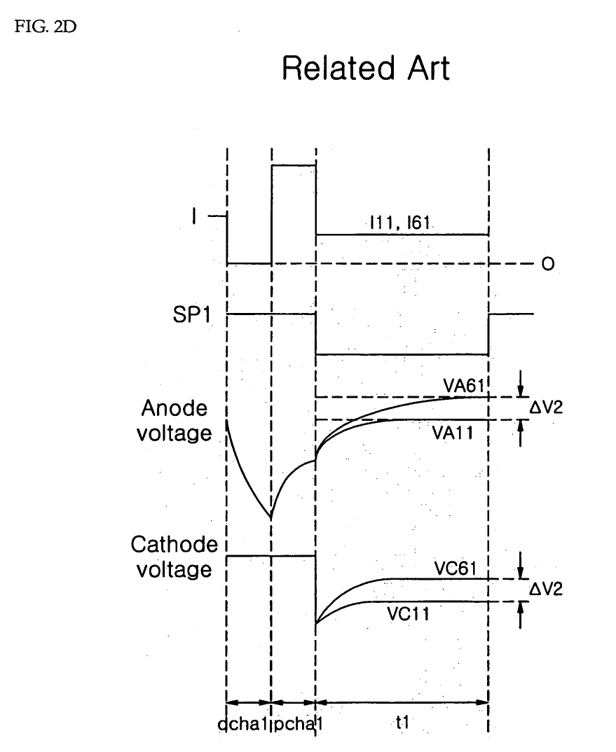

### DESCRIPTION OF EMBODIMENTS

Hereinafter, the preferred embodiments of the present invention will be explained in more detail with reference to the accompanying drawings.

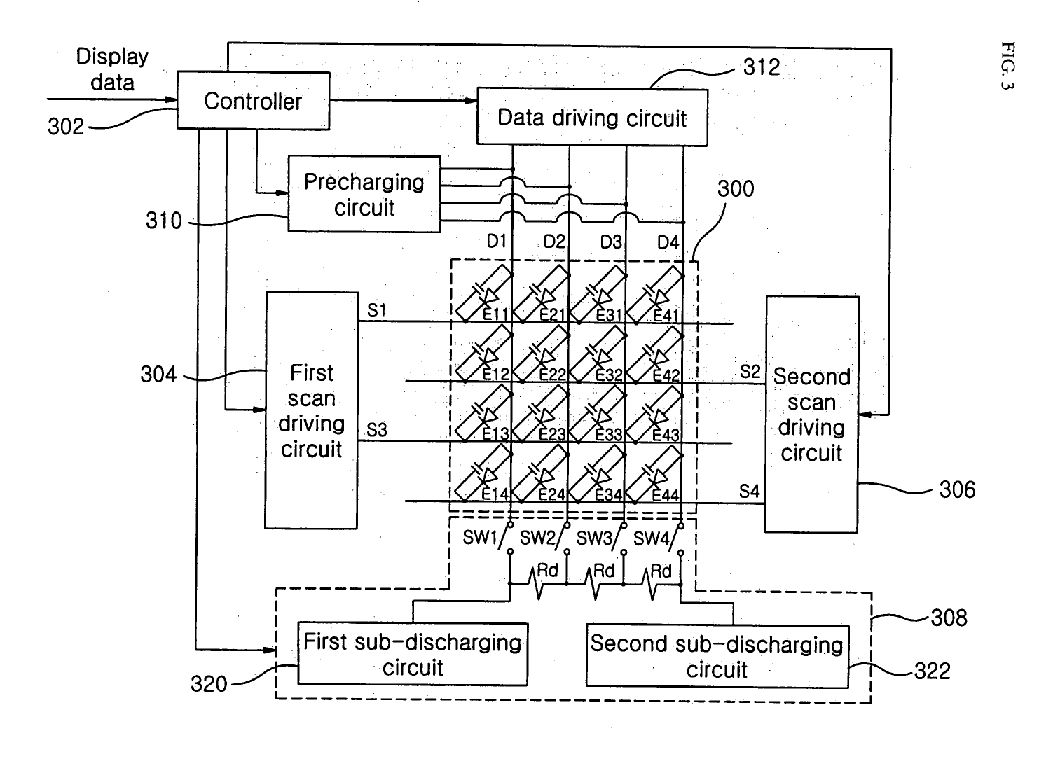

FIG. 3 is a block diagram illustrating a light emitting device according to a first embodiment of the present invention.

In FIG. 3, the light emitting device of the present invention includes a panel 300, a controller 302, a scan driving circuit 304, a second scan driving circuit 306, a discharging circuit 308, a precharging circuit 310 and a data driving circuit 312.

The light emitting device according to one embodiment of the present invention includes an organic electroluminescent device, a plasma display panel, a liquid crystal display, and others. Hereinafter, the organic electroluminescent device will be described as an example of the light emitting device for convenience of the description.

The panel 300 has a plurality of pixels E11 to E44 formed in cross areas of data lines D1 to D4 and scan lines SI to S4.

In case that the light emitting device is organic electroluminescent device, at least one of the pixels E11 to E44 includes an anode electrode layer, an organic layer and a cathode electrode layer formed in sequence on a substrate.

The controller 302 receives display data, e.g. RGB data from an outside apparatus (not shown), and controls the scan driving circuits 304 and 306, the discharging circuit 308, the precharging circuit 310 and the data driving circuit 312. In addition, the controller 302 may store the received display data in a memory included therein.

The first scan driving circuit 304 transmits first scan signals to some of the scan lines S1 to S4, e.g. S1 and S3. The second scan driving circuit 306 transmits second scan signals to the other scan lines S2 and S4. As a result, the scan lines S1 to S4 are coupled to a luminescent source having a low scan voltage, e.g. ground. Hereinafter, the luminescent source is assumed by a ground.

The discharging circuit 308 discharges at least one data line up to discharge voltage corresponding to cathode voltage of pixel related to the data line, and includes a first sub-discharging circuit 320 and a second sub-discharging circuit 322. Here, the cathode voltage corresponds to a resistor (hereinafter, referred to as “scan line resistor) of scan line related to the cathode voltage and data current passing through the scan line.

In another embodiment of the present invention, the discharging circuit 308 discharges the data line up to the discharge voltage corresponding to the cathode voltage of the pixel and referring to capacitance of a capacitor related to the pixel.

In still another embodiment of the present invention, the discharging circuit 308 discharges the data lines D1 to D4 up to discharge voltages corresponding to cathode voltages of the pixels E11 to E44.

The first sub-discharging circuit 320 is coupled to the data line D1, i.e. first outmost data line of the data lines D1 to D4 through a switch SW1 as shown in FIG. 3, and so provides a first voltage to the first outmost data line D1 when discharging.

The second sub-discharging circuit 322 is coupled to the data line D4, i.e. second outmost data line of the data lines D1 to D4, and so provides a second voltage to the second outmost data line D4 when discharging.

In one embodiment of the present invention, the second voltage has magnitude different from the first voltage. The sub-discharging circuits 320 and 322 will be described in detail with reference to the accompanying drawings.

The precharging circuit 310 provides precharge current corresponding to the display data to the discharged data lines D1 to D4 under control of the controller 302.

The data driving circuit 312 provides data signals, i.e. data currents corresponding to the display data to the precharged data lines D1 to D4 under control of the controller 302. As a result, the pixels E11 to E44 emit light.

Hereinafter, a process of driving the light emitting device of the present invention will be described in detail. Here, pluralities of display data are assumed to be inputted in sequence to the controller 302.

The first scan line S1 is coupled to a luminescent source, preferably ground, and the other scan lines S2 to S4 are coupled to a non-luminescent source having the same magnitude (V2) as a driving voltage of the light emitting device, e.g. voltage corresponding to maximum brightness of data current.

Then, first data currents corresponding to first display data are provided to the data lines D1 to D4. In this case, the first data currents are passed to the ground through the data lines D1 to D4, the pixels E11 to E41 and the first scan line S1. As a result, the pixels E11 to E41 corresponding to the first scan line S1 emit light.

Subsequently, the data lines D1 to D4 are discharged up to discharge voltages corresponding to cathode voltages of the pixels E12 to E42 during a discharge period of time.

Then, the data lines D1 to D4 are precharged up to precharge voltages corresponding to a second display data inputted to the controller 302 after the first display data are inputted to the controller 302.

Subsequently, the second scan line S2 is coupled to the ground, and the other scan lines S1, S3 and S4 are coupled to the non-luminescent source.

Then, second data currents corresponding to the second display data are provided to the data lines D1 to D4. As a result, pixels E12 to E42 corresponding to the second scan line S2 emit light.

Pixels E13 to E43 corresponding to a third scan line S3 emit light, and then pixels E14 to E44 corresponding to a fourth scan line S4 emit light through the method described above. Subsequently, the above process of emitting light in the pixels E11 to E44 is repeated in units of the scan lines S1 to S4, i.e. frame.

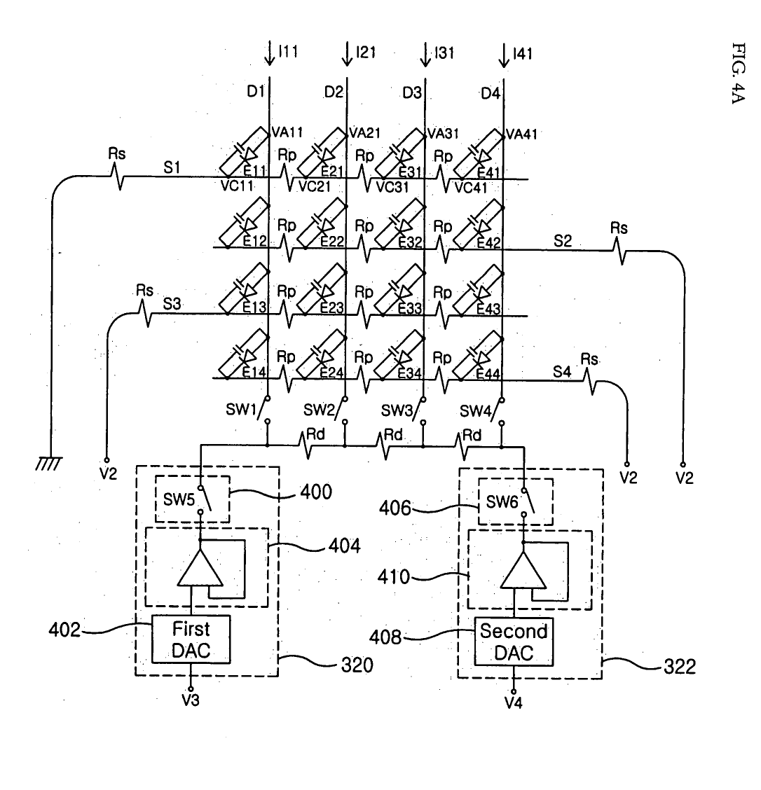

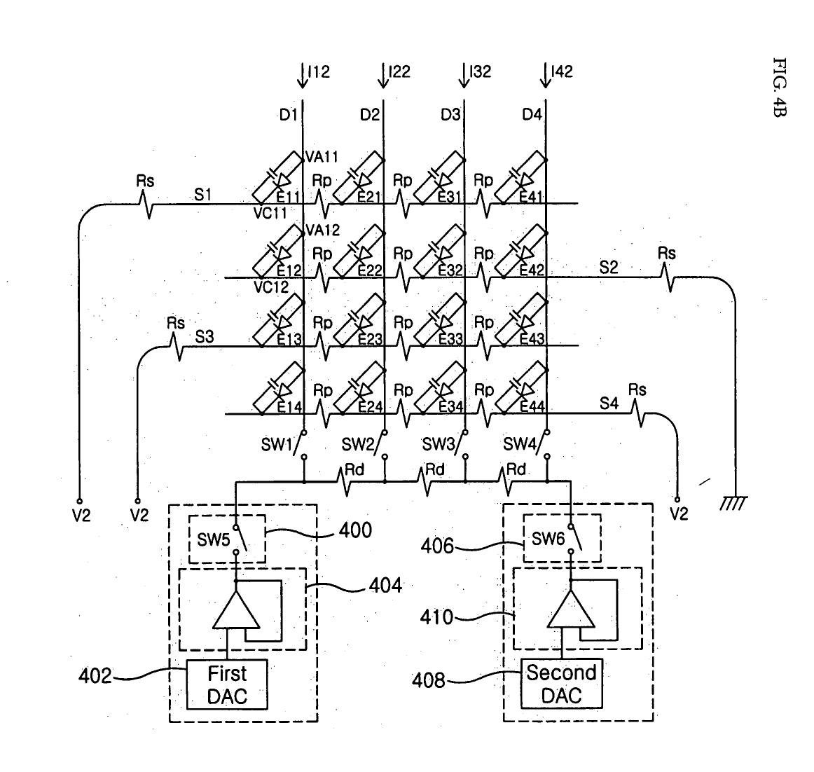

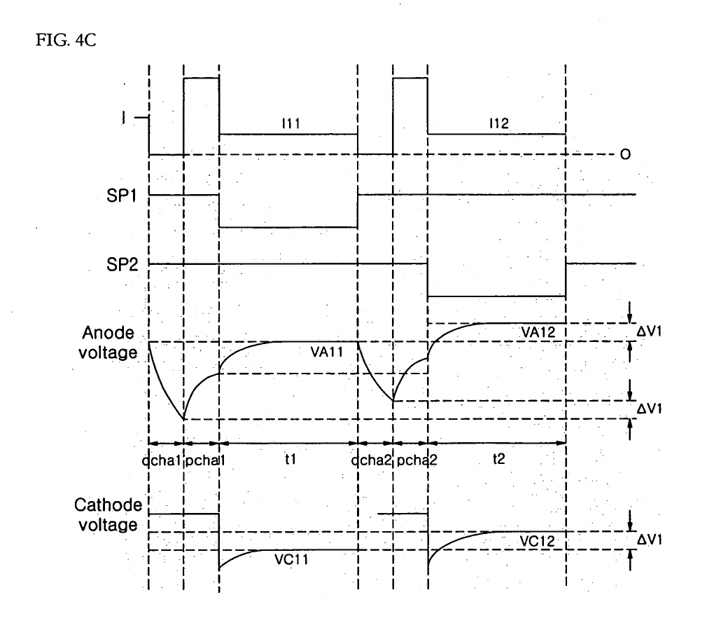

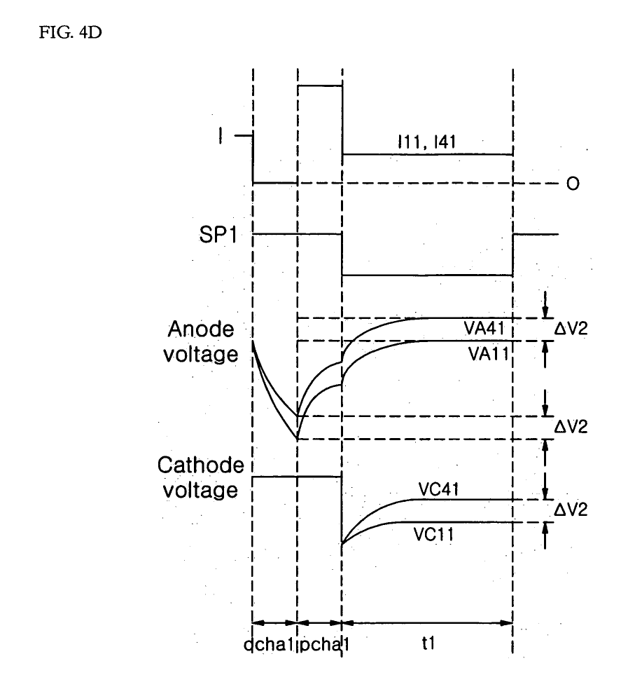

FIG. 4A and FIG. 4B are views illustrating schematically circuitries of the light emitting device in FIG. 3. FIG. 4C and FIG. 4D are timing diagrams illustrating a process of driving the light emitting device.

In FIG. 4A, the first sub-discharging circuit 320 includes a first switch (SW5) 400, a first digital-analog converter (first DAC) 402 and a first OP amplifier 404.

The second sub-discharging circuit 322 includes a second switch (SW6) 406, a second DAC 408 and a second OP amplifier 410.

Hereinafter, the process of driving the light emitting device will be described after cathode voltages VC11 to VC41 of the pixels E11 to E41 corresponding to the first scan lines S1 are compared.

As shown in FIG. 4A, a resistor between the pixel Eli and the ground is Rs, and a resistor between the pixel E21 and the ground is Rs+Rp. In addition, a resistor between a pixel E31 and the ground is Rs+2Rp, and a resistor between a pixel E41 and the ground is Rs+3Rp.

Here, it is assumed that data currents I11 to I41 having the same magnitude are provided to the data lines D1 to D4 so that the pixels E11 to E41 have the same brightness.

In this case, the data currents I11 to I41 are passed to the ground through corresponding pixel and the first scan line S1. Accordingly, since the data currents I11 to I41 have the same magnitude, each of the cathode voltages VC11 to VC41 of the pixels E11 to E41 are proportioned to a corresponding pixel and the resistor between the corresponding pixel and the ground. Hence, the values are high in the order of VC41, VC31, VC21 and VC11.

In FIG. 4B, a resistor between a pixel E12 and the ground is Rs+3Rp, and is higher than the resistor between the pixel E11 and the ground. Here, it is assumed that the data current I11 passing through the first data line D1 when the first scan line S1 is coupled to the ground is identical to data current I12 passing through the first data line D1 when a second scan line S2 is coupled to the ground. In this case, because cathode voltages VC11 and VC12 of the pixels E11 and E12 are proportioned to corresponding resistor, the cathode voltage VC12 is higher than the cathode voltage VC11.

Hereinafter, the process of driving the light emitting device will be described in detail.

The discharging circuit 308 discharges the data lines D1 to D4.

Hereinafter, a process of discharging the data lines D1 to D4 will be described in detail.

The first switch SW5 and the second switch SW6 are turned on, and the scan lines S1 to S4 are coupled to the non-luminescent source. Accordingly, the pixels E11 to E44 do not emit light.

Subsequently, the first DAC 402 outputs a first level voltage in accordance with a first outside voltage V3 inputted from an outside apparatus, and the outputted first level voltage is inputted to the first OP amplifier 404. In addition, the second DAC 408 outputs a second level voltage in accordance with a second outside voltage V4 inputted from an outside apparatus, and the outputted second level voltage is inputted to the second OP amplifier 410.

Then, the first OP amplifier 404 provides a first OP amp output voltage to the data line D1, i.e. first outmost data line of the data lines D1 to D4 in accordance with the inputted first level voltage, and so the first outmost data line D1 has a first voltage. Further, the second OP amplifier 410 provides a second OP amp output voltage to the data line D4, i.e. second outmost data line in accordance with the inputted second level voltage, and so the second outmost data line D4 has a second voltage. Here, in one embodiment of the present invention, the second voltage has magnitude different from the first voltage. In this case, the cathode voltage VC41 is higher than the cathode voltage VC11, and thus the second voltage is higher than the first voltage.

In case that the first outmost data line D1 and the second outmost data line D4 have the first voltage and the second voltage, respectively, the data lines D1 to D4 have voltages of sequential magnitude in accordance with voltage distribution by resistors Rd. That is, the data lines D1 to D4 are discharged up to discharge voltages having different magnitude when discharging. It is desirable that the data lines D1 to D4 are discharged up to discharge voltages corresponding to cathode voltages of pixels related thereto.

On the other hand, there are capacitors related to the pixels E11 to E44 in the light emitting device as shown in FIG. 4A and FIG. 4B, and the capacitors affects level of discharge voltage. Accordingly, the light emitting device discharges the data lines D1 to D4 up to discharge voltages corresponding to cathode voltages related thereto and referring to the capacitances in case that data currents provided to the data lines D1 to D4 have the same magnitude.

In another embodiment of the present invention, the OP amplifiers 404 and 410 may output certain currents so that the data lines D1 to D4 have the discharge voltages corresponding to the cathode voltages of the pixels related thereto.

Hereinafter, the pixel E41 is assumed to have the same brightness as the pixel E11. In other words, data currents I11 and I41 having the same magnitude are provided to the data lines D1 to D4 during a first luminescent period of time (t1).

In this case, since the cathode voltage VC41 is higher than the cathode voltage VC11, the data line D4 is discharged up to discharge voltage higher than discharge voltage corresponding to the first data line D1 during a first discharge period of time (dcha1) as shown in FIG. 4D.

Subsequently, the data lines D1 to D4 are precharged during a first precharge period of time (pcha1). In this case, because the data line D4 is discharged to discharge voltage higher than discharge voltage corresponding to the data line D1, the data line D4 is precharged up to precharge voltage higher than precharge voltage corresponding to the data line D1.

Then, the first scan line D1 is coupled to the luminescent source, e.g. ground, and the other scan lines S2 to S4 are coupled to the non-luminescent source.

Subsequently, data currents I11 and I41 having the same magnitude and corresponding to first display data are provided to the data lines D1 and D4, respectively. In this case, since the pixel E41 is preset to have the same brightness as the pixel E11, anode voltages VA11 and VA41 of the pixels E11 and E41 rise from corresponding precharge voltage to a voltage different from corresponding cathode voltages VC11 and VC41 by a certain level, and then the voltages VA11 and VA41 are saturated. Here, the anode voltages VA11 and VA41 refer to the cathode voltages VC11 and VC41 and the capacitors. This is because a pixel emits a light having brightness corresponding to difference of its anode voltage and its cathode voltage.

For example, in case that the cathode voltage VC11 of the pixel E11 and the cathode voltage VC41 of the pixel E41 are 1V and 2V, respectively, the anode voltage VA41 of the pixel E41 is saturated with 7V when the anode voltage VA11 of the pixel E11 is saturated with 6V. In this case, because the data line D4 is precharged up to the second precharge voltage higher than the first precharge voltage corresponding to the data line D1, the anode voltage VA11 of the pixel E11 rises from the first precharge voltage, e.g. 3V to 6V, and then is saturated with 6V. Whereas, the anode voltage VA41 of the pixel E41 rises from the second precharge voltage, e.g. 4V to 7V, and then is saturated with 7V. In other words, the anode voltages VA11 and VA41 of the pixels E11 and E41 rise from corresponding cathode voltages VC11 and VC41 by the same level, e.g. 3V as shown in FIG. 4D, and then are saturated. Accordingly, charge amount consumed until the anode voltage VA41 of the pixel E41 is saturated is substantially identical to that consumed until the anode voltage VA11 of the pixel E11 is saturated. Hence, in case that the pixels E11 and E41 are preset to emit light having the same brightness, the brightness (VA41-VC41) of the pixel E41 is substantially identical to the brightness (VA11-VC11) of the pixel E11.

In addition, the pixels E21 and E31 operate in the above method. Accordingly, when the pixels E11 to E41 are preset to have the same brightness, the pixels E11 to E41 emit light having substantially the same brightness.

Then, the scan lines S1 to s4 are coupled to the non-luminescent source, and the switches SW1 to SW6 are turned on.

Subsequently, the first sub-discharging circuit 320 provides a third voltage to the first outmost data line D1, and the second sub-discharging circuit 322 provides a fourth voltage to the second outmost data line D4. Here, since the cathode voltage VC12 is higher than the cathode voltage VC42, the third voltage is higher than the fourth voltage. As a result, the data lines D1 to D4 are discharged up to discharge voltages having sequential magnitude.

Hereinafter, the discharge voltages corresponding to the pixels E11 and E12 will be compared.

Because the cathode voltage VC12 of the pixel E12 is higher than the cathode voltage VC11 of the pixel E11, in the first discharge period of time (dcha1), the data line D1 is discharged up to a discharge voltage higher than in the second discharge period of time (dcha2) as shown in FIG. 4C.

Then, precharge currents corresponding to second display data are provided to the data lines D1 to D4. Here, the second display data are inputted to the controller 302 after the first display data are inputted to the controller 302.

Subsequently, as shown in FIG. 4B, the second scan line S2 is coupled to the ground, and the other scan lines S1, S3 and S4 are coupled to the non-luminescent source.

Then, data currents I12 to I42 corresponding to the second display data are provided to the data lines D1 to D4. In this case, though the cathode voltage VC12 of the pixel E12 is higher than the cathode voltage VC11 of the pixel E11, charge amount consumed until the anode voltage VA12 of the pixel E12 is saturated is substantially identical to that consumed until the anode voltage VA11 of the pixel E11 is saturated since precharge voltage corresponding to the pixel E12 is higher than that corresponding to the pixel E11. Here, the data currents I11 and I12 have the same magnitude. Accordingly, in case that the pixel E12 is preset to have the same brightness as the pixel E11, the pixel E12 emits a light having brightness (VA12-VC12) which is substantially identical to brightness (VA11-VC11) of the pixel E11.

In brief, in the light emitting device of the present invention, discharge voltage and precharge voltage of data line are adjusted in accordance with cathode voltage of corresponding pixel and capacitance of capacitor related to the pixel unlike the light emitting device described in Related Art. Accordingly, when pixels are preset to have the same brightness, the pixels emit light having the same brightness irrespective of their cathode voltages. Hence, in the light emitting device of the present invention, a cross-talk phenomenon is not occurred in the panel 300.

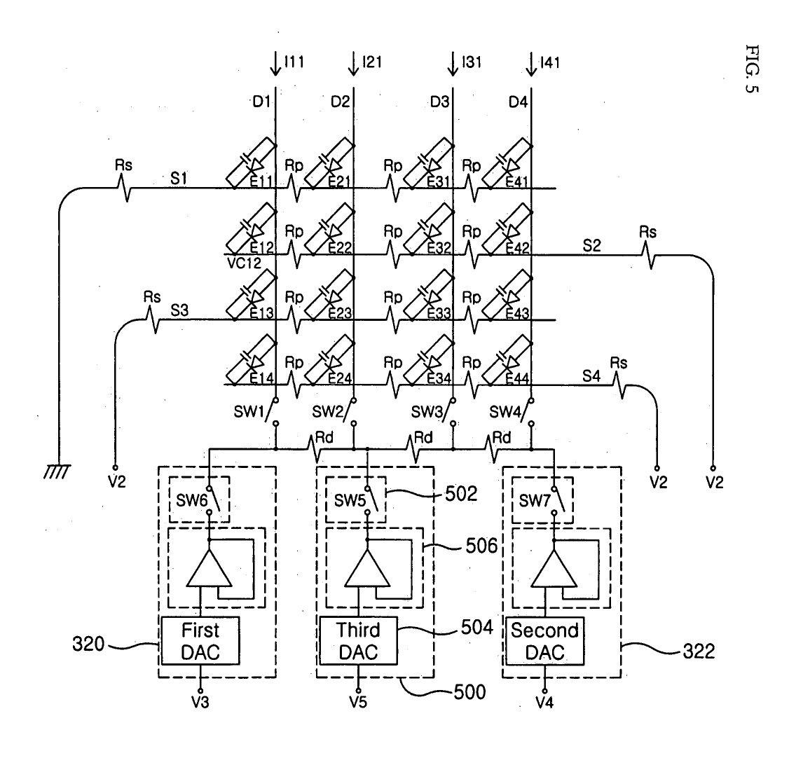

FIG. 5 is a view illustrating circuitry of a light emitting device according to a second embodiment of the present invention.

In FIG. 5, the light emitting device of the present embodiment, further includes at least one third sub-discharging circuit 500.

The third sub-discharging circuit 500 is coupled to a part between outmost data lines D1 and D4 as shown in FIG. 5, and provides a certain voltage to corresponding data line.

In the first embodiment, cathode voltages corresponding to one scan line have sequential magnitude when data currents passing through the data lines D1 to D4 are the same magnitude. Hence, the light emitting device compensates cathode voltages by using two sub-discharging circuits 320 and 322, and so the data lines D1 to D4 are discharged up to discharge voltages corresponding to the cathode voltages of pixels related thereto.

However, the sub-discharging circuits 320 and 322 may not adequately compensate the cathode voltages. Accordingly, the light emitting device in the second embodiment further includes at least one third sub-discharging circuit 500 besides the sub-discharging circuits 320 and 322 in order to compensate adequately the cathode voltages.

The third sub-discharging circuit 500 according to one embodiment of the present invention includes a third switch 502, a third DAC 504 and a third OP amplifier 506. Since the elements in the third sub-discharging circuit 500 are the same in the first embodiment, any further description concerning the same elements will be omitted.

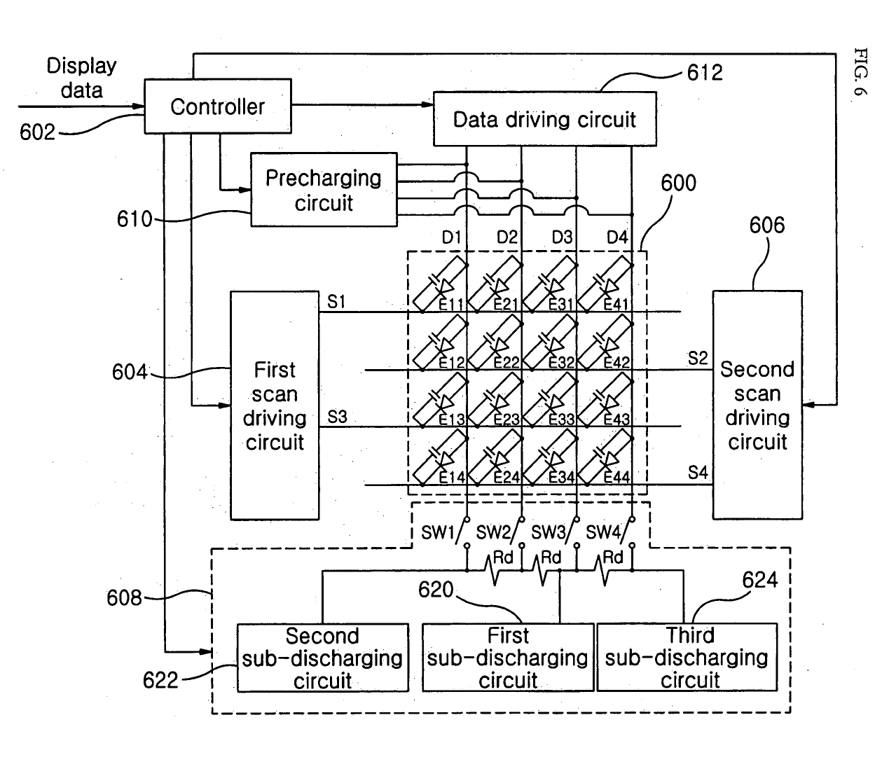

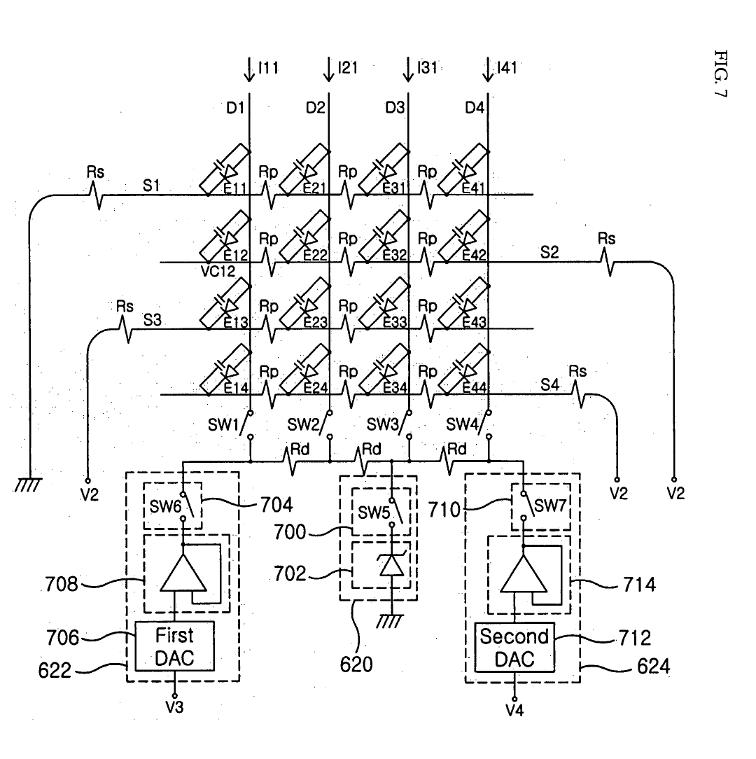

FIG. 6 is a view illustrating a light emitting device according to a third embodiment of the present invention. FIG. 7 is a view illustrating circuitry of the light emitting device in FIG. 6.

In FIG. 6, the light emitting device of the present embodiment includes a panel 600, a controller 602, a first scan driving circuit 604, a second scan driving circuit 606, a discharging circuit 608, a precharging circuit 610 and a data driving circuit 612.

Since the elements of the present embodiment except the discharging circuit 608 are the same as in the first embodiment, any further description concerning the same elements will be omitted.

The discharging circuit 608 includes a first sub-discharging circuit 620, a second sub-discharging circuit 622 and a third sub-discharging circuit 624.

The first sub-discharging circuit 620 discharges data lines D1 to D4 up to a certain voltage. For example, the first sub-discharging circuit 620 discharges the data lines D1 to D4 up to zener voltage of zener diode 702 by using the zener diode 702 included therein as shown in FIG. 7.

The second and third sub-discharging circuits 622 and 624 compensate cathode voltages of pixels E11 to E44 like the sub-discharging circuits 320 and 322 in the first embodiment.

For instance, the second and third sub-discharging circuits 622 and 624 include switches 704 and 710, DACs 706 and 712, and OP amplifiers 708 and 714.

In the first embodiment, the OP amplifiers 404 and 410 compensate the cathode voltages VC11 to VC44 using currents outputted therefrom, and thus power consumption of the light emitting device is high. However, in the third embodiment, the light emitting device compensates the cathode voltages VC11 to VC44 using the OP amplifiers 708 and 714 after discharging the data lines D1 to D4 up to a certain voltage using the zener diode 702, and so power consumption of the light emitting device is lower than that in the first embodiment.

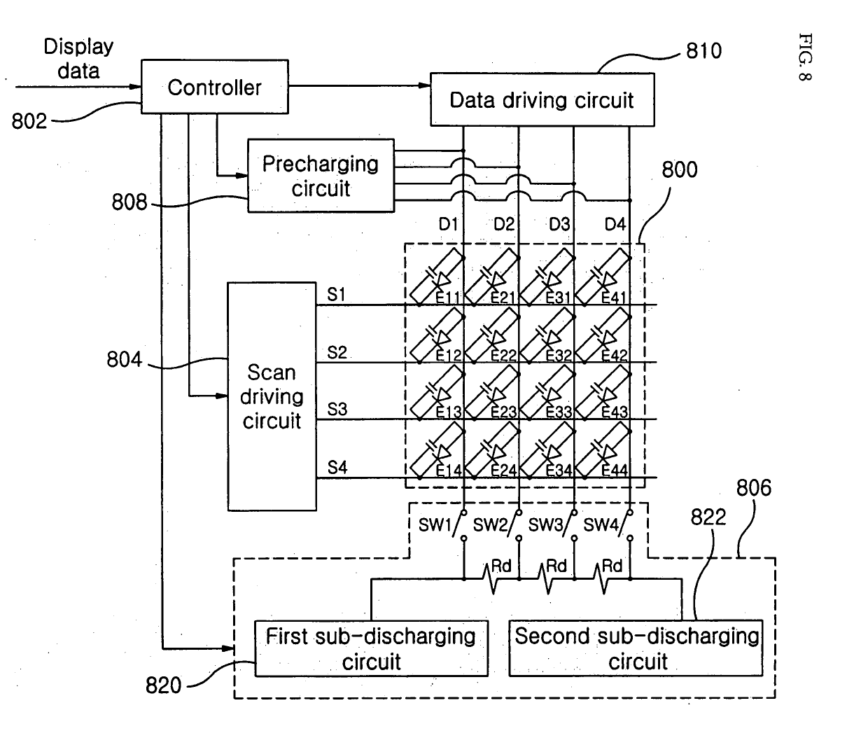

FIG. 8 is a view illustrating a light emitting device according to a fourth embodiment of the present invention.

In FIG. 8, the light emitting device of the present embodiment includes a panel 800, a controller 802, a scan driving circuit 804, a discharging circuit 806, a precharging circuit 808 and a data driving circuit 810. Since the elements in the present embodiment except the scan driving circuit 804 are the same as in the first embodiment, any further description concerning the same elements will be omitted.

In the light emitting device in the fourth embodiment, the scan driving circuit 804 is formed in one direction of the panel 800 unlike the other embodiments.

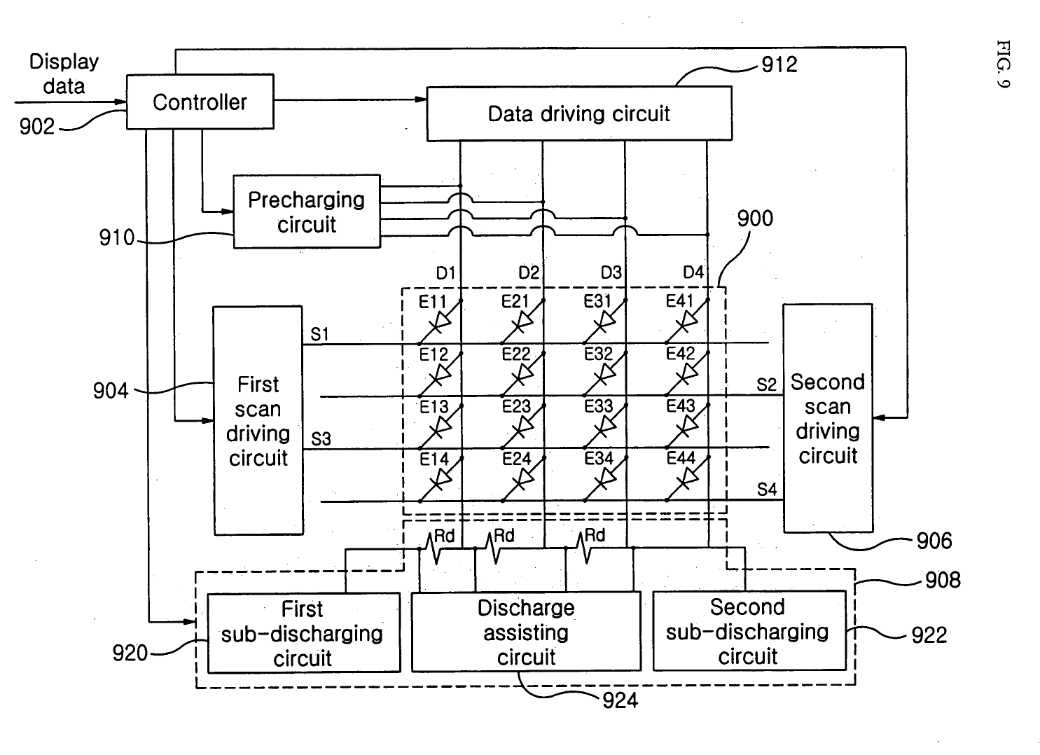

FIG. 9 is a view illustrating a light emitting device according to a fifth embodiment of the present invention.

In FIG. 9, the light emitting device of the present invention includes a panel 900, a controller 902, a first scan driving circuit 904, a second scan driving circuit 906, a discharging circuit 908, a precharging circuit 910 and a data driving circuit 912.

The panel 900 has a plurality of pixels E11 to E44 formed in cross areas of data lines D1 to D4 and scan lines S1 to S4.

The controller 902 receives display data from an outside apparatus (not shown), and controls the scan driving circuits 904 and 906, the discharging circuit 908, the precharging circuit 910 and the data driving circuit 912.

The first scan driving circuit 904 transmits first scan signals to some of the scan lines S1 to S4, e.g. S1 and S3.

The second scan driving circuit 906 transmits second scan signals to the other scan lines S2 and S4. As a result, the scan lines S1 to S4 are coupled to a luminescent source, e.g. ground.

Hereinafter, the luminescent source is assumed to be ground.

The discharging circuit 908 discharges at least one data line up to discharge voltage corresponding to cathode voltage of pixel related to the data line, preferably discharges the data lines D1 to D4 up to discharge voltages corresponding to cathode voltages of the pixels E11 to E44. Here, the cathode voltages correspond to resistors of scan lines corresponding to pixels related thereto in case that data currents provided to the data lines D1 to D4 are the same magnitude.

The discharging circuit 908 includes a first sub-discharging circuit 920, a second sub-discharging circuit 922 and a discharge assisting circuit 924.

The first sub-discharging circuit 920 is coupled to a first outmost data line D1 of outmost data lines D1 and D4 of the data lines D1 to D4 as shown in FIG. 9, and provides a first voltage to the first outmost data line D1 when discharging.

The second sub-discharging circuit 922 is coupled to the second outmost data line D4, and provides a second voltage to the second outmost data line D4 when discharging.

In one embodiment of the present invention, the second voltage is different from the first voltage.

The discharge assisting circuit 924 facilitates discharging.

The sub-discharging circuits 920 and 922 and the discharge assisting circuit 924 will be described in detail with reference to the accompanying drawings.

The prechargin circuit 910 provides precharge currents corresponding to the display data to the discharged data lines D1 to D4 under control of the controller 902.

The data driving circuit 912 provides data signals, i.e. data currents corresponding to the display data to the precharged data lines D1 to D4 under control of the controller 902. As a result, the pixels E11 to E44 emit light.

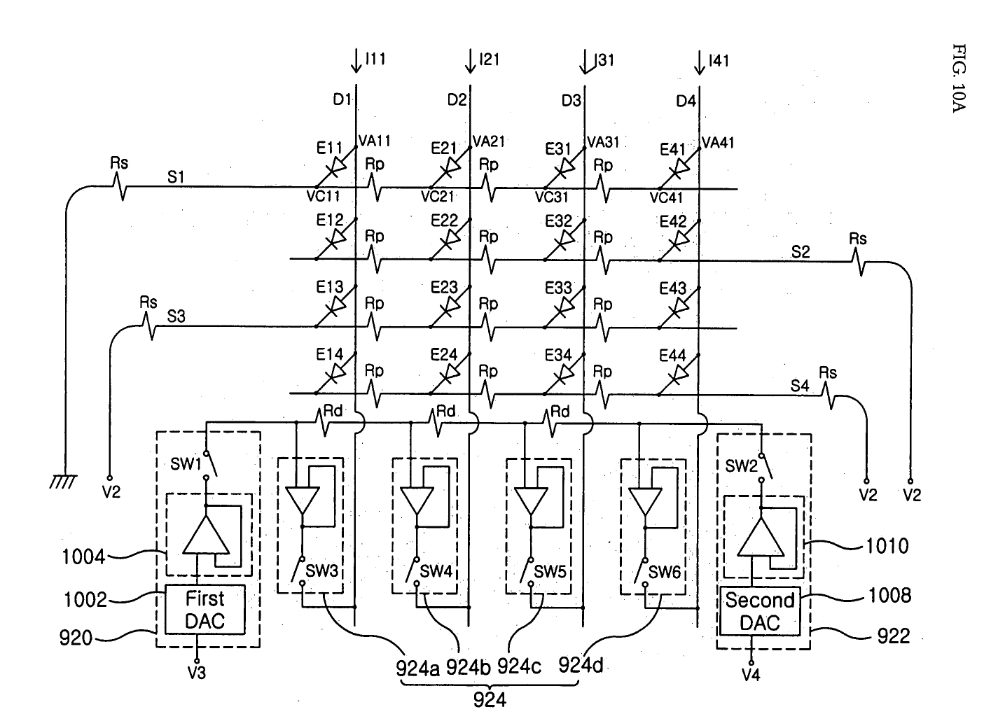

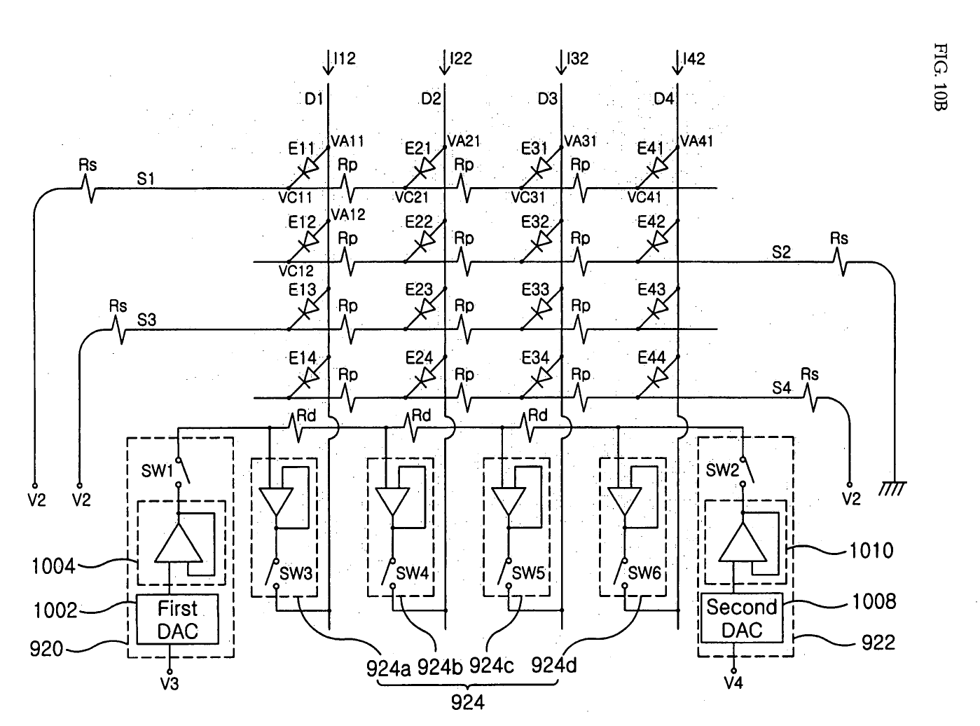

FIG. 10A and FIG. 10B are views illustrating schematically circuitries of the light emitting device in FIG. 9.

FIG. 10A, the first sub-discharging circuit 920 includes a first switch SW1, a first DAC 1002 and a first OP amplifier 1004.

The second sub-discharging circuit 922 includes a second switch SW2, a second DAC 1008 and a second OP amplifier 1010.

The discharge assisting circuit 924 has at least one discharge assisting device, e.g. third OP amplifier coupled to data line. It is desirable that the third OP amplifiers are coupled to the data lines D1 to D4.

Hereinafter, the process of driving the light emitting device will be described after cathode voltages VC11 to VC41 of the pixels E11 to E41 corresponding to the first scan lines S1 are compared.

As shown in FIG. 10A, a resistor between the pixel E11 and the ground is Rs, and a resistor between the pixel E21 and the ground is Rs+Rp. In addition, a resistor between a pixel E31 and the ground is Rs+2Rp, and a resistor between a pixel E41 and the ground is Rs+3Rp.

Here, it is assumed that data currents I11 to I41 having the same magnitude are provided to the data lines D1 to D4 so that the pixels E11 to E41 have the same brightness.

In this case, the data currents I11 to I41 are passed to the ground through corresponding pixel and the first scan line Si. Accordingly, since the data currents I11 to I41 have the same magnitude, each of the cathode voltages VC11 to VC41 of the pixels E11 to E41 are proportioned to a corresponding pixel and the resistor between the corresponding pixel and the ground. Hence, the values are high in the order of VC41, VC31, VC21 and VC11.

FIG. 10B, a resistor between a pixel E12 and the ground is Rs+3Rp, and is higher than the resistor between the pixel E11 and the ground. Here, it is assumed that the data current I11 passing through the first data line D1 when the first scan line S1 is coupled to the ground is identical to data current I12 passing through the first data line D1 when a second scan line S2 is coupled to the ground. In this case, because cathode voltages VC11 and VC12 of the pixels E11 and E12 are proportioned to corresponding resistor, the cathode voltage VC12 is higher than the cathode voltage VC11.

Hereinafter, the process of driving the light emitting device will be described in detail.

The discharging circuit 908 discharges the data lines D1 to D4.

Hereinafter, a process of discharging the data lines D1 to D4 will be described in detail.

The switches SW1 to SW6 are turned on, and the scan lines S1 to S4 are coupled to the non-luminescent source. Accordingly, the pixels E11 to E44 do not emit light.

Subsequently, the first DAC 1002 outputs a first level voltage in accordance with a first outside voltage V3 inputted from an outside apparatus, and the outputted first level voltage is inputted to the first OP amplifier 1004. In addition, the second DAC 1008 outputs a second level voltage in accordance with a second outside voltage V4 inputted from an outside apparatus, and the outputted second level voltage is inputted to the second OP amplifier 1010.

Then, the first OP amplifier 1004 provides a first OP amp output voltage to the data line D1, i.e. first outmost data line in accordance with the inputted first level voltage, and so the first outmost data line D1 has a first voltage. Further, the second OP amplifier 1010 provides a second OP amp output voltage to the data line D4, i.e. second outmost data line in accordance with the inputted second level voltage, and so the second outmost data line D4 has a second voltage. Here, in one embodiment of the present invention, the second voltage has magnitude different from the first voltage. In this case, the cathode voltage VC41 is higher than the cathode voltage VC11, and thus the second voltage is higher than the first voltage.

In case that the first outmost data line D1 and the second outmost data line D4 have the first voltage and the second voltage, respectively, the data lines D1 to D4 have voltages of sequential magnitude in accordance with voltage distribution by resistors Rd. That is, the data lines D1 to D4 are discharged up to discharge voltages having different magnitude when discharging. It is desirable that the data lines D1 to D4 are discharged up to discharge voltages corresponding to cathode voltages of pixels related thereto.

In another embodiment of the present invention, the OP amplifiers 1004 and 1010 may output certain currents, thereby discharging the data lines D1 to D4 up to discharge voltages corresponding to cathode voltages of pixels the data lines D1 to D4.

Hereinafter, the pixel E41 is assumed to have the same brightness as the pixel E11. In other words, data currents I11 and I41 having the same magnitude are provided to the data lines D1 to D4 during a first luminescent period of time (t1).

In this case, since the cathode voltage VC41 is higher than the cathode voltage VC11, the data line D4 is discharged up to discharge voltage higher than discharge voltage corresponding to the first data line D1 during a first discharge period of time (dcha1) as shown in FIG. 4D. Here, the light emitting device of the present embodiment enhances discharging velocity using the third OP amplifiers as described below.

Subsequently, the data lines D1 to D4 are precharged during a first precharge period of time (pcha1). In this case, because the data line D4 is discharged to discharge voltage higher than discharge voltage corresponding to the data line D1, the data line D4 is precharged up to precharge voltage higher than precharge voltage corresponding to the data line D1.

Then, the first scan line S1 is coupled to the luminescent source, e.g. ground, and the other scan lines S2 to S4 are coupled to the non-luminescent source.

Subsequently, data currents I11 and I41 having the same magnitude and corresponding to first display data are provided to the data lines D1 and D4, respectively. In this case, since the pixel E41 is preset to have the same brightness as the pixel Eli, anode voltages VA11 and VA41 of the pixels E11 and E41 rise from corresponding precharge voltage to a voltage different from corresponding cathode voltages VC11 and VC41 by a certain level, and then the anode voltages VA11 and VA41 are saturated. This is because a pixel emits a light having brightness corresponding to difference of its anode voltage and its cathode voltage.

For example, in case that the cathode voltage VC11 of the pixel E11 and the cathode voltage VC41 of the pixel E41 are 1V and 2V, respectively, the anode voltage V41 of the pixel E41 is saturated with 7V when the anode voltage VA11 of the pixel E11 is saturated with 6V In this case, because the data line D4 is precharged up to the second precharge voltage higher than the first precharge voltage corresponding to the data line D1, the anode voltage VA11 of the pixel E11 rises from the first precharge voltage, e.g. 3V to 6V, and then is saturated with 6V. Whereas, the anode voltage VA41 of the pixel E41 rises from the second precharge voltage, e.g. 4V to 7V, and then is saturated with 7V. In other words, the anode voltages VA11 and VA41 of the pixels E11 and E41 rise from corresponding cathode voltages VC11 and VC41 by the same level, e.g. 3V as shown in FIG. 4D, and then are saturated. Accordingly, charge amount consumed until the anode voltage VA41 of the pixel E41 is saturated is substantially identical to that consumed until the anode voltage VA11 of the pixel E11 is saturated. Hence, in case that the pixels E11 and E41 are preset to emit light having the same brightness, the brightness (VA41-VC41) of the pixel E41 is substantially identical to the brightness (VA11-VC11) of the pixel E11.

In addition, the pixels E21 and E31 operate in the above method. Accordingly, when the pixels E11 to E41 are preset to have the same brightness, the pixels E11 to E41 emit light having substantially the same brightness.

Hereinafter, the process of driving the light emitting device will be described continuously.

Then, the scan lines S1 to s4 are coupled to the non-luminescent source, and the switches SW1 to SW6 are turned on.

Subsequently, the first sub-discharging circuit 920 provides a third OP amp output voltage to the first outmost data line D1, and so the first outmost data line D1 has a third voltage. The second sub-discharging circuit 922 provides a fourth OP amp output voltage to the second outmost data line D4, and so the second outmost data line D4 has a fourth voltage. Here, since the cathode voltage VC12 is higher than the cathode voltage VC42, the third voltage is higher than the fourth voltage. As a result, the data lines D1 to D4 are discharged up to discharge voltages having sequential magnitude.

Hereinafter, the discharge voltages corresponding to the pixels E11 and E12 will be compared.

Because the cathode voltage VC12 of the pixel E12 is higher than the cathode voltage VC11 of the pixel E11, in the first discharge period of time (dcha1), the data line D1 is discharged up to a discharge voltage higher than in the second discharge period of time (dcha2) as shown in FIG. 4C.

Then, precharge currents corresponding to second display data are provided to the data lines D1 to D4. Here, the second display data are inputted to the controller 902 after the first display data are inputted to the controller 902.

Subsequently, as shown in FIG. 10B, the second scan line S2 is coupled to the ground, and the other scan lines S1, S3 and S4 are coupled to the non-luminescent source.

Then, data currents I12 to I42 corresponding to the second display data are provided to the data lines D1 to D4. In this case, though the cathode voltage VC12 of the pixel E12 is higher than the cathode voltage VC11 of the pixel E11, charge amount consumed until the anode voltage VA12 of the pixel E12 is saturated is substantially identical to that consumed until the anode voltage VA11 of the pixel E11 is saturated since precharge voltage corresponding to the pixel E12 is higher than that corresponding to the pixel E11. Here, the data currents I11 and I12 have the same magnitude. Accordingly, in case that the pixel E12 is preset to have the same brightness as the pixel E11, the pixel E12 emits a light having brightness (VA12-VC12) which is substantially identical to brightness (VA11-VC11) of the pixel E11.

In short, in the light emitting device of the present invention, discharge voltage and precharge voltage of data line are adjusted in accordance with cathode voltage of corresponding pixel and capacitance of capacitor related to the pixel unlike the light emitting device described in Related Art. Accordingly, when pixels are preset to have the same brightness, the pixels emit light having the same brightness irrespective of their cathode voltages. Hence, in the light emitting device of the present invention, a cross-talk phenomenon is not occurred in the panel 900.

Hereinafter, function of the discharge assisting circuit 924 will be described in detail.

The discharge assisting circuits 924A to 924D includes switches SW3 to SW6 and a third OP amplifiers which are a discharge assisting device as shown in FIG. 10A and FIG. 10B.

The switches SW3 to SW6 are turned on when discharging.

The third OP amplifiers provides voltages outputted from the OP amplifiers 1004 and 1010 or voltages formed by resistors Rd to corresponding data lines, and the data lines D1 to D4 are discharged up to discharge voltages corresponding to cathode voltages of pixels related to the data lines D1 to D4. That is, the third OP amplifier may control a discharging time required for discharging the data lines D1 to D4 up to the discharge voltages, i.e. discharging velocity.

In the light emitting device according to one embodiment of the present invention, resistors Rd corresponding to a part between the data lines D1 to D4 are preset to have high resistance, and which will be described below.

A first light emitting device which does not include the third OP amplifier and a second light emitting device including the third OP amplifier will be compared. Here, resistor Rd is about 100Ω in the first light emitting device, whereas resistor Rd is about 1 k Ω in the second light emitting device. In addition, difference of the second voltage and the first voltage is 1V.

In the first light emitting device, current passing through a line corresponding to the resistor Rd is 10 mA (1V/100Ω). Whereas, in the second light emitting device, current passing a line corresponding to the resistor Rd is 1 mA (1V/1 kΩ). Accordingly, power consumption of the second light emitting device which includes the third OP amplifier and include the resistor Rd having high resistance is lower than that of the first light emitting device which does not include the third OP amplifier and include the resistor Rd having low resistance.

On the other hand, the discharging time required for discharging the data line D1 to D4 may be increased as the resistor Rd is increased, but the light emitting device of the present invention reduces the discharging time required for discharging the data lines D1 to D4 up to desired discharging voltage by using the third OP amplifiers for functioning as buffer as shown in FIG. 10A. Accordingly, the light emitting device may enhance the discharging time and power consumption characteristics.

The light emitting device according to another embodiment of the present invention may discharge the data lines D1 to D4 up to desired discharging voltages using the OP amplifiers 1004 and 1010 after discharging the data lines D1 to D4 up to a certain discharge voltage using e.g. zener diode. Accordingly, the power consumption of the light emitting device in the present embodiment may be lower than that of the light emitting device in the fifth embodiment which controls the discharge voltage using only currents outputted from the OP amplifiers 1004 and 1010.

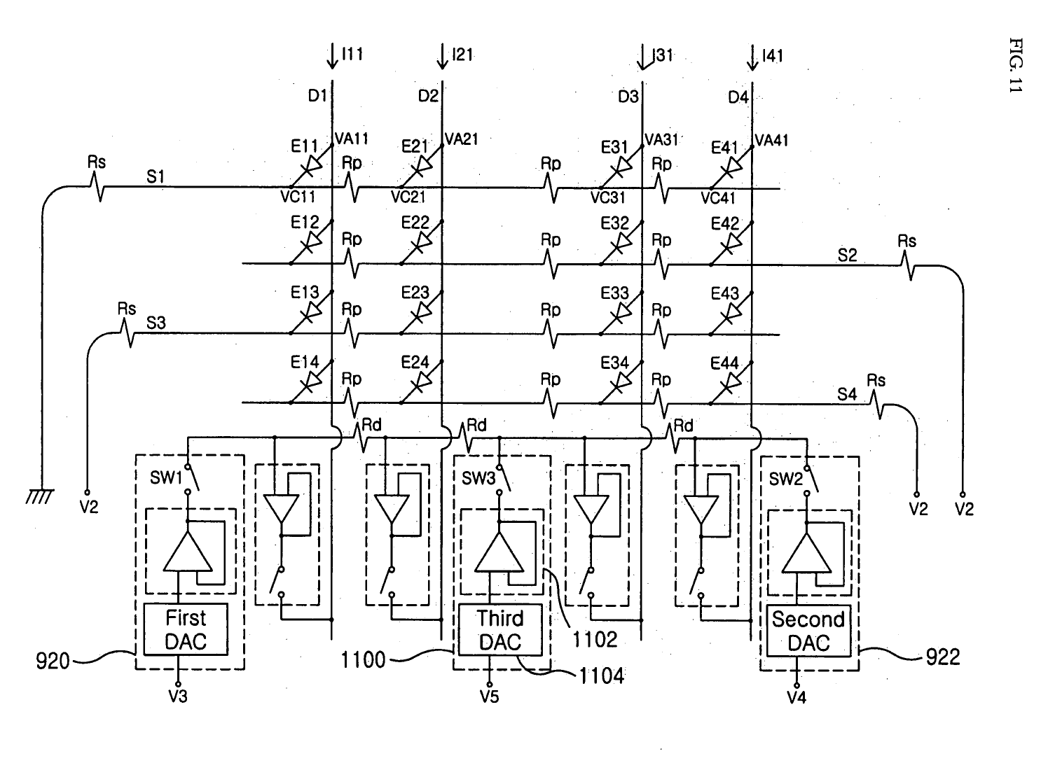

FIG. 11 is a view illustrating circuitry of a light emitting device according to a sixth embodiment of the present invention.

In FIG. 11, the light emitting device of the present embodiment further includes at least one third sub-discharging circuit 1100 comparing to the light emitting device in the fifth embodiment.

The third sub-discharging circuit 1100 is coupled to one data line between outmost data lines D1 and D4 of data lines D1 to D4, and provides corresponding data line to a certain voltage.

In the fifth embodiment, cathode voltages corresponding to one scan line have sequential magnitude when data currents passing through the data lines D1 to D4 are the same magnitude. Hence, the light emitting device compensates cathode voltages by using two sub-discharging circuits 920 and 922, and so the data lines D1 to D4 are discharged up to discharge voltages corresponding to the cathode voltages of pixels related thereto.

However, the sub-discharging circuits 920 and 922 may not adequately compensate the cathode voltages. Accordingly, the light emitting device in the sixth embodiment further includes at least one third sub-discharging circuit 1100 besides the sub-discharging circuits 920 and 922 in order to compensate adequately the cathode voltages.

The third sub-discharging circuit 1100 according to one embodiment of the present invention includes a third switch SW3, a third OP amplifier 1102 and a third DAC 1104. Since the elements in the third sub-discharging circuit 1100 are the same in the fifth embodiment, any further description concerning the same elements will be omitted.

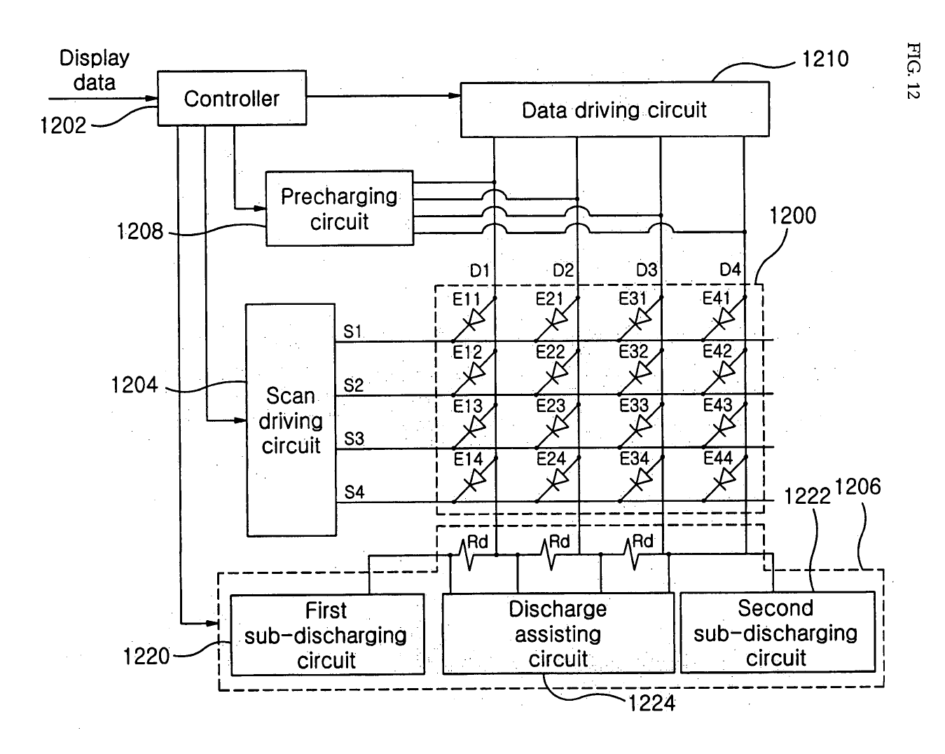

FIG. 12 is a view illustrating a light emitting device according to a seventh embodiment of the present invention.

In FIG. 12, the light emitting device of the present invention includes a panel 1200, a controller 1202, a scan driving circuit 1204, a discharging circuit 1206, a precharging circuit 1208 and a data driving circuit 1210.

Since the elements of the present embodiment except the scan driving circuit 1204 are the same as in the fifth embodiment, any further description concerning the same elements will be omitted.

In the light emitting device in the seventh embodiment, the scan driving circuit 1204 is formed in one direction of the panel 1200 unlike the fifth and sixth embodiments.

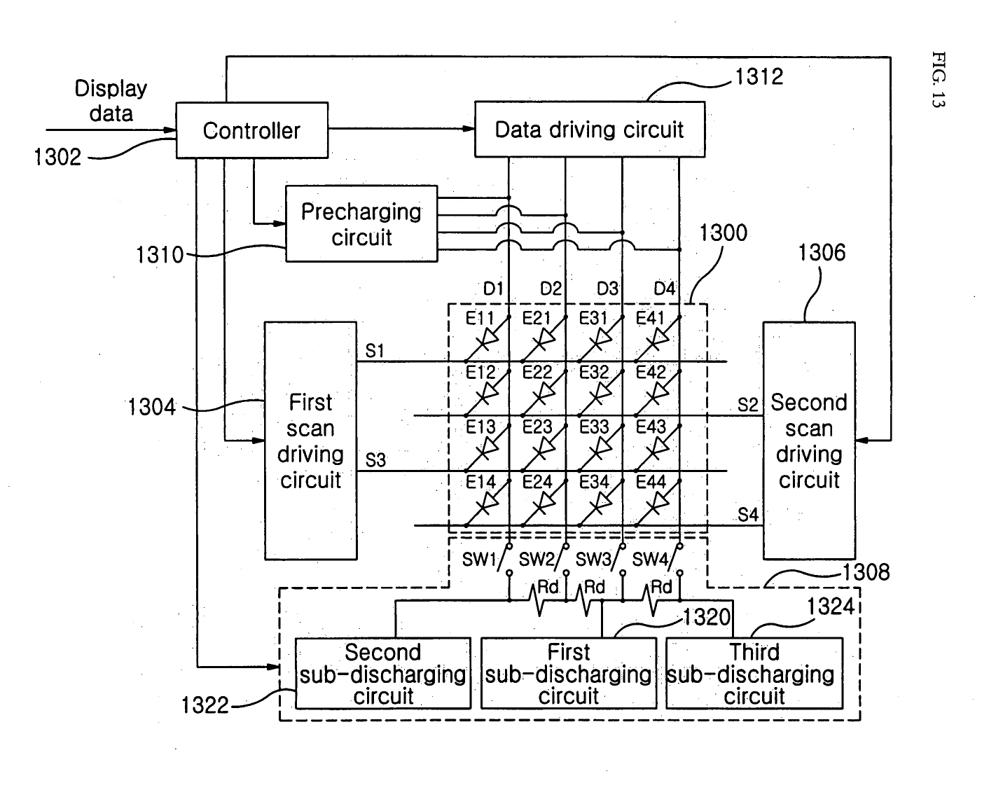

FIG. 13 is a view illustrating a light emitting device according to an eighth embodiment of the present invention.

In FIG. 13, the light emitting device of the present invention includes a panel 1300, a controller 302, a first scan driving circuit 1304, a second scan driving circuit 1306, a discharging circuit 1308, a precharging circuit 1310 and a data driving circuit 1312.

The panel 1300 includes a plurality of pixels E11 to E44 formed in cross areas of data lines D1 to D4 and scan lines S1 to S4.

The controller 1302 receives display data from an outside apparatus (not shown), and controls the scan driving circuits 1304 and 1306, the discharging circuit 1308, the precharging circuit 310 and the data driving circuit 1312.

The first scan driving circuit 1304 transmits first scan signals to some of the scan lines S1 to S4, e.g. S1 and S3.

The second scan driving circuit 1306 transmits second signals to the other scan line S2 and S4. As a result, the scan lines S1 to S4 are coupled in sequence to a luminescent source, preferably ground. Hereinafter, the luminescent source is assumed to be the ground.

The discharging circuit 1308 includes a first sub-discharging circuit 1320, a second sub-discharging circuit 1322 and a third sub-discharging circuit 1324.

The first sub-discharging circuit 1320 discharges at least one data line up to a first discharge voltage during a first sub-discharge period of time.

The second sub-discharging circuit 1322 is coupled to a first outmost data line D1 of outmost data lines D1 and D4 of the data lines D1 to D4 through a switch SW1 as shown in FIG. 13, and provides a first voltage to the first outmost data line D1 during a second sub-discharge period of time.

The third sub-discharging circuit 1324 is coupled to the second outmost data line D4 through a switch SW4, and provides a second voltage to the second outmost data line D4 during the second sub-discharge period of time.

In one embodiment of the present invention, the second voltage is higher than the first voltage. As a result, the data line discharged up to the first discharge voltage is discharged up to a second discharge voltage corresponding to cathode voltage of pixel related to the data line by the second and third sub-discharging circuits 1322 and 1324. This will be described in detail with reference to the accompanying drawings.

The precharging circuit 1310 provides precharge currents corresponding to the display data to the discharged data lines D1 to D4 under control of the controller 1302.

The data driving circuit 1312 provides data signals, i.e. data currents corresponding to the display data to the precharged data lines D1 to D4 under control of the controller 1302. As a result, the pixels E11 to E44 emit light.

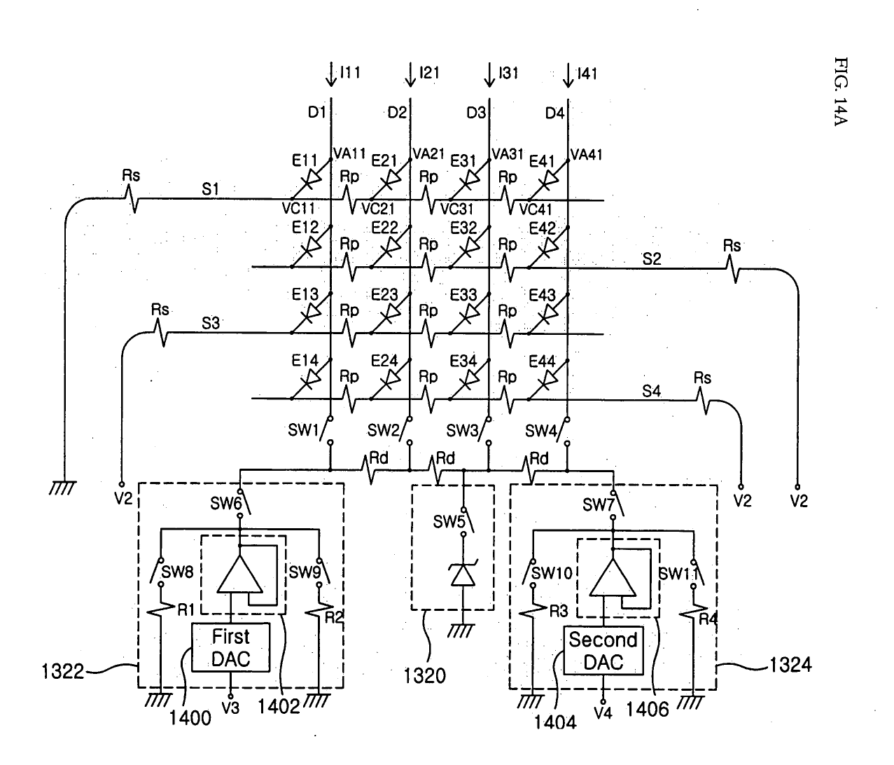

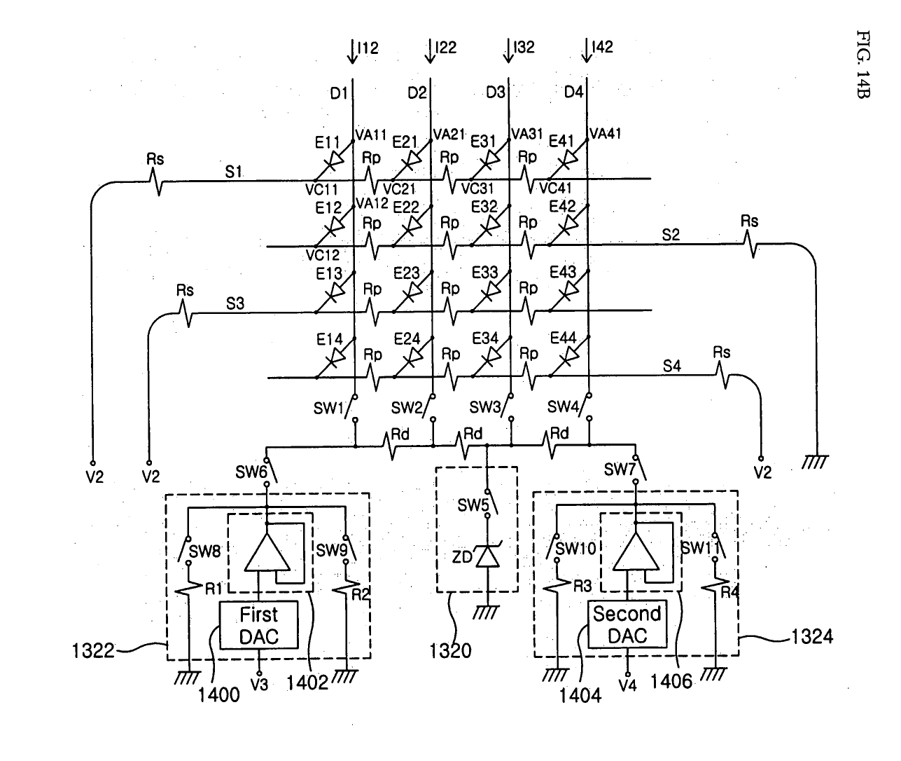

FIG. 14A and FIG. 14B are views illustrating schematically circuitries of the light emitting device in FIG. 13.

In FIG. 14A, the first sub-discharging circuit 1320 includes a first switch SW5 and a zener diode ZD.

The second sub-discharging circuit 1322 includes a second switch SW6, a first DAC 1400, a first OP amplifier 1402, a fourth switch SW8, a first resistor R1, a fifth switch SW9 and a second resistor R2.

The resistors R1 and R2 have different values, and are coupled in parallel to the first OP amplifier 1402.

The third sub-discharging circuit 1324 includes a third switch SW7, a second DAC 1404, a second OP amplifier 1406, a sixth switch SW10, a third resistor R3, a seventh switch SW11 and a fourth resistor R4.

The resistors R3 and R4 have different values, and are coupled in parallel to the second OP amplifier 1406.

Hereinafter, the process of driving the light emitting device will be described after cathode voltages VC11 to VC41 of the pixels E11 to E41 corresponding to the first scan lines S1 are compared.

As shown in FIG. 14A, a resistor between the pixel E11 and the ground is Rs, and a resistor between the pixel E21 and the ground is Rs+Rp. In addition, a resistor between a pixel E31 and the ground is Rs+2Rp, and a resistor between a pixel E41 and the ground is Rs+3Rp.

Here, it is assumed that data currents I11 to I41 having the same magnitude are provided to the data lines D1 to D4 so that the pixels E11 to E41 have the same brightness.

In this case, the data currents I11 to I41 are passed to the ground through corresponding pixel and the first scan line S1. Accordingly, since the data currents I11 to I41 have the same magnitude, each of the cathode voltages VC11 to VC41 of the pixels E11 to E41 are proportioned to a corresponding pixel and the resistor between the corresponding pixel and the ground. Hence, the values are high in the order of VC41, VC31, VC21 and VC11.

In FIG. 14B, a resistor between a pixel E12 and the ground is Rs+3Rp, and is higher than the resistor between the pixel E11 and the ground. Here, it is assumed that the data current I11 passing through the first data line D1 when the first scan line S1 is coupled to the ground is identical to data current I12 passing through the first data line D1 when a second scan line S2 is coupled to the ground. In this case, because cathode voltages VC11 and VC12 of the pixels E11 and E12 are proportioned to corresponding resistor, the cathode voltage VC12 is higher than the cathode voltage VC11.

Hereinafter, the process of driving the light emitting device will be described in detail.

The discharging circuit 1308 discharges the data lines D1 to D4.

Hereinafter, a process of discharging the data lines D1 to D4 will be described in detail.

The discharging circuit 1308 discharges the data lines D1 to D4. In this case, the scan lines S1 to S4 are coupled to the non-luminescent source.

Hereinafter, a process of discharging the data lines D1 to D4 will be described in detail.

The switches SW1 to SW5 are turned on during the first sub-discharge period of time, and the switches SW6 and SW7 are turned off Accordingly, the data lines D1 to D4 are coupled to the zener diode ZD during the first sub-discharge period of time. As a result, the data lines D1 to D4 are discharged up to a zener voltage of the zener diode ZD. Here, the data lines D1 to D4 may be discharged up to discharging voltage higher than the zener voltage in accordance with length of the first sub-discharge period of time.

Then, the switch SW5 is turned off, and the switches SW1 to SW4 maintains on condition. In addition, the switches SW6 and SW7 are turned on.

Subsequently, the first DAC 1400 outputs a first level voltage in accordance with a first outside voltage V3 inputted from an outside apparatus, and the outputted first level voltage is inputted to the first OP amplifier 1402. In addition, the second DAC 1404 outputs a second level voltage in accordance with a second outside voltage V4 inputted from an outside apparatus, and the outputted second level voltage is inputted to the second OP amplifier 1406.

Then, the first OP amplifier 1402 provides a first OP amp output voltage to the data line D1, i.e. first outmost data line in accordance with the inputted first level voltage so that the first outmost data line D1 has a first voltage. In this case, one of the switches SW8 and SW9 is selectively turned on. Particularly, in case that the first voltage is high voltage, resistor having smaller resistance of the resistors R1 and R2 is coupled to the first OP amplifier 1402. Whereas, in case that the first voltage is low voltage, resistor having higher resistance of the resistors R1 and R2 is coupled to the first OP amplifier 1402. For example, in case that the first voltage is less than about 1.5V, the resistor R1 having smaller resistance of the resistors R1 and R2 is coupled to the first OP amplifier 1402. Whereas, in case that the first voltage is more than 1.5V, the resistor R2 having higher resistance of the resistors R1 and R2 is coupled to the first OP amplifier 1402. As a result, the light emitting device of the present invention maintains constantly or similarly the second sub-discharge period of time T2 irrespective of the magnitude of the first voltage. That is, the second sub-discharge period of time T2 may have optimal discharge period of time.

Further, the second OP amplifier 1406 provides a second OP amp output voltage to the data line D4, i.e. second outmost data line in accordance with the inputted second level voltage, and so the second outmost data line D4 has a second voltage. Here, in one embodiment of the present invention, the second voltage has magnitude different from the first voltage. In particular, the cathode voltage VC41 is higher than the cathode voltages VC31, VC21 and VC11, and thus the second voltage is higher than the first voltage. In this case, one of the switches SW10 and SW11 is turned on. That is, in case that the second voltage is high voltage, resistor having lower resistance of the resistors R3 and R4 is coupled to the second OP amplifier 1406. Whereas, in case that the second voltage is low voltage, resistor having higher resistance of the resistors R3 and R4 is coupled to the second OP amplifier 1406.

Hereinafter, the pixel E41 is assumed to have the same brightness as the pixel E11. In other words, data currents I11 and I41 having the same magnitude are provided to the data lines D1 to D4 during a first luminescent period of time (t1).

The first data line D1 is discharged up to a first discharge voltage up to the zener diode ZD during the first sub-discharge period of time (T1) of a first discharge period of time (dcha1), and discharged up to a second discharge voltage corresponding to the cathode voltage VC11. In other words, the first data line D1 is discharged up to the discharge voltage corresponding to the cathode voltage VC11 of the pixel E11 during the first discharge period of time (dcha1) as shown in FIG. 4D.

Whereas, the data line D4 is discharged up to the first discharge voltage or discharge voltage different from the first voltage by the zener diode ZD during the first sub-discharge period of time (T1), and discharged up to a fourth discharge voltage corresponding to the cathode voltage VC41 during the second sub-discharge period of time (T2). In this case, because the cathode voltage VC41 is higher than the cathode voltage VC11, the fourth discharge voltage is higher than the second discharge voltage. That is, the data line D4 is discharged up to discharge voltage corresponding to the cathode voltage VC41 of the pixel E41 during the first discharge period of time (dcha1) as shown in FIG. 4D.

Subsequently, the data lines D1 to D4 are precharged during a first precharge period of time (pcha1). In this case, because the data line D4 is discharged to discharge voltage higher than discharge voltage corresponding to the data line D1, the data line D4 is precharged up to precharge voltage higher than precharge voltage corresponding to the data line D1.

Then, the first scan line S1 is coupled to the luminescent source, e.g. ground, and the other scan lines S2 to S4 are coupled to the non-luminescent source as shown in FIG. 14A.

Subsequently, data currents I11 and I41 having the same magnitude and corresponding to first display data are provided to the data lines D1 and D4, respectively. In this case, since the pixel E41 is preset to have the same brightness as the pixel E11, anode voltages VA11 and VA41 of the pixels E11 and E41 rise from corresponding precharge voltage to a voltage different from corresponding cathode voltages VC11 and VC41 by a certain level, and then the anode voltages VA11 and VA41 are saturated. This is because a pixel emits a light having brightness corresponding to difference of its anode voltage and its cathode voltage.

For example, in case that the cathode voltage VC11 of the pixel E11 and the cathode voltage VC41 of the pixel E41 are 1V and 2V, respectively, the anode voltage V41 of the pixel E41 is saturated with 7V when the anode voltage VA11 of the pixel E11 is saturated with 6V. In this case, because the data line D4 is precharged up to the second precharge voltage higher than the first precharge voltage corresponding to the data line D1, the anode voltage VA11 of the pixel E11 rises from the first precharge voltage, e.g. 3V to 6V, and then is saturated with 6V. Whereas, the anode voltage VA41 of the pixel E41 rises from the second precharge voltage, e.g. 4V to 7V, and then is saturated with 7V. In other words, the anode voltages VA11 and VA41 of the pixels E11 and E41 rise from corresponding cathode voltages VC11 and VC41 by the same level, e.g. 3V as shown in FIG. 4D, and then are saturated. Accordingly, charge amount consumed until the anode voltage VA41 of the pixel E41 is saturated is substantially identical to that consumed until the anode voltage VA11 of the pixel E11 is saturated. Hence, in case that the pixels E11 and E41 are preset to emit light having the same brightness, the brightness (VA41-VC41) of the pixel E41 is substantially identical to the brightness (VA11-VC11) of the pixel E11.

In addition, the pixels E21 and E31 operate in the above method. Accordingly, when the pixels E11 to E41 are preset to have the same brightness, the pixels E11 to E41 emit light having substantially the same brightness.

Hereinafter, the process of driving the light emitting device will be described continuously.

Then, the scan lines S1 to s4 are coupled to the non-luminescent source, and the switch SW5 is turned on. As a result, the data lines D1 to D4 is discharged up to the first discharge voltage or a third discharge voltage.

Subsequently, the switches SW6 and SW7 are turned on. Accordingly, the second sub-discharging circuit 1322 provides a third voltage to the first outmost data line D1, and the third sub-discharging circuit 1324 provides a fourth voltage to the second outmost data line D4. Here, since the cathode voltage VC12 is higher than the cathode voltage VC42, the third voltage is higher than the fourth voltage. As a result, the data lines D1 to D4 are discharged up to discharge voltages having sequential magnitude.

Hereinafter, the discharge voltages corresponding to the pixels E11 and E12 will be compared.

In FIG. 4C, the data line D1 is discharged up to the first discharge voltage by the zener diode ZD during the first sub-discharge period of time (T1), and discharged up to the second discharge voltage corresponding to the cathode voltage VC11 during the second sub-discharge period of time (T2).

Whereas, the data line D1 is discharged up to a first discharge voltage or the third discharge voltage by the zener diode ZD during a third sub-discharge period of time (T3), and discharged up to the fourth discharge voltage corresponding to the cathode voltage VC12 during a fourth sub-discharge period of time (T4). In this case, since the cathode voltage VC12 is higher than the cathode voltage VC11, the fourth discharge voltage is higher than the second discharge voltage.

Then, precharge currents corresponding to second display data are provided to the data lines D1 to D4. Here, the second display data are inputted to the controller 1302 after the first display data are inputted to the controller 1302.

Subsequently, as shown in FIG. 14B, the second scan line S2 is coupled to the ground, and the other scan lines S1, S3 and S4 are coupled to the non-luminescent source.

Then, data currents I12 to I42 corresponding to the second display data are provided to the data lines D1 to D4. In this case, though the cathode voltage VC12 of the pixel E12 is higher than the cathode voltage VC11 of the pixel E11, charge amount consumed until the anode voltage VA12 of the pixel E12 is saturated is substantially identical to that consumed until the anode voltage VA11 of the pixel E11 is saturated since precharge voltage corresponding to the pixel E12 is higher than that corresponding to the pixel E11 as shown in FIG. 4C. Here, the data currents I11 and I12 have the same magnitude. Accordingly, in case that the pixel E12 is preset to have the same brightness as the pixel E11, the pixel E12 emits a light having brightness (VA12-VC12) which is substantially identical to brightness (VA11-VC11) of the pixel E11.

In brief, in the light emitting device of the present invention, discharge voltage and precharge voltage of data line are adjusted in accordance with cathode voltage of corresponding pixel and capacitance of capacitor related to the pixel unlike the light emitting device described in Related Art. Accordingly, when pixels are preset to have the same brightness, the pixels emit light having the same brightness irrespective of their cathode voltages. Hence, in the light emitting device of the present invention, a cross-talk phenomenon is not occurred in the panel 1300.

In a light emitting device according to another embodiment of the present invention, three or more resistors may be coupled to OP amplifier. Here, at least one of the resistors is selectively coupled to the OP amplifier.

In a light emitting device according to still another embodiment of the present invention, capacitor may be coupled in parallel to at least one resistor.

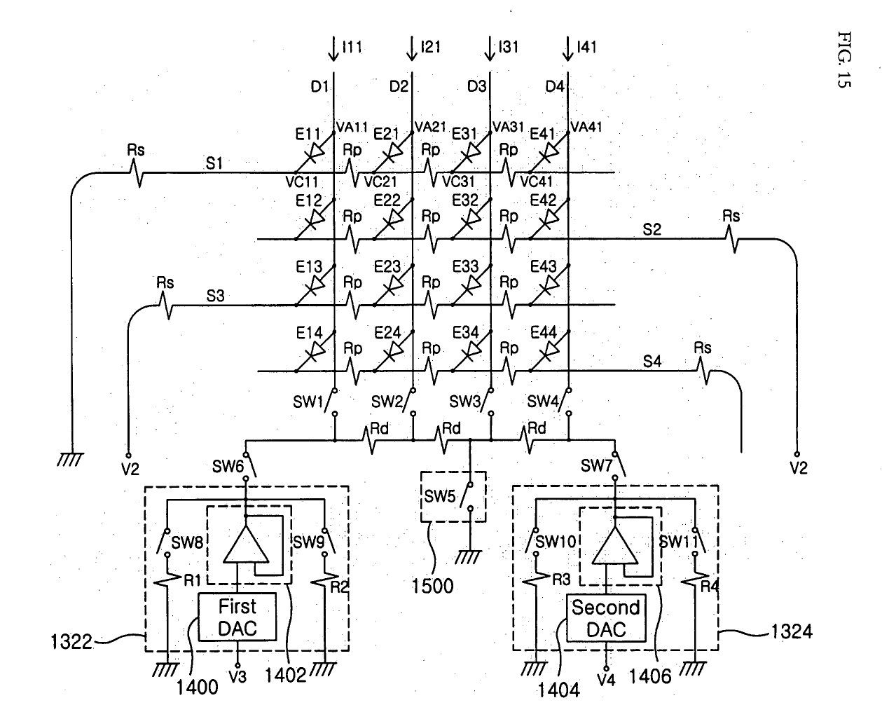

FIG. 15 is a view illustrating a light emitting device according to a ninth embodiment of the present invention.

Since the elements of the present embodiment except a first sub-discharging circuit 1500 are the same as in the eighth embodiment, any further description concerning the same elements will be omitted.

The first sub-discharging circuit 1500 includes a switch SW5 coupled to a ground.

The switch SW5 is turned on during a first sub-discharge period of time, and so the data lines D1 to D4 are discharged during the first sub-discharge period of time. Here, the data lines D1 to D4 are discharged up to a certain discharge voltage that is not 0V because length of the first sub-discharge period of time is limited.

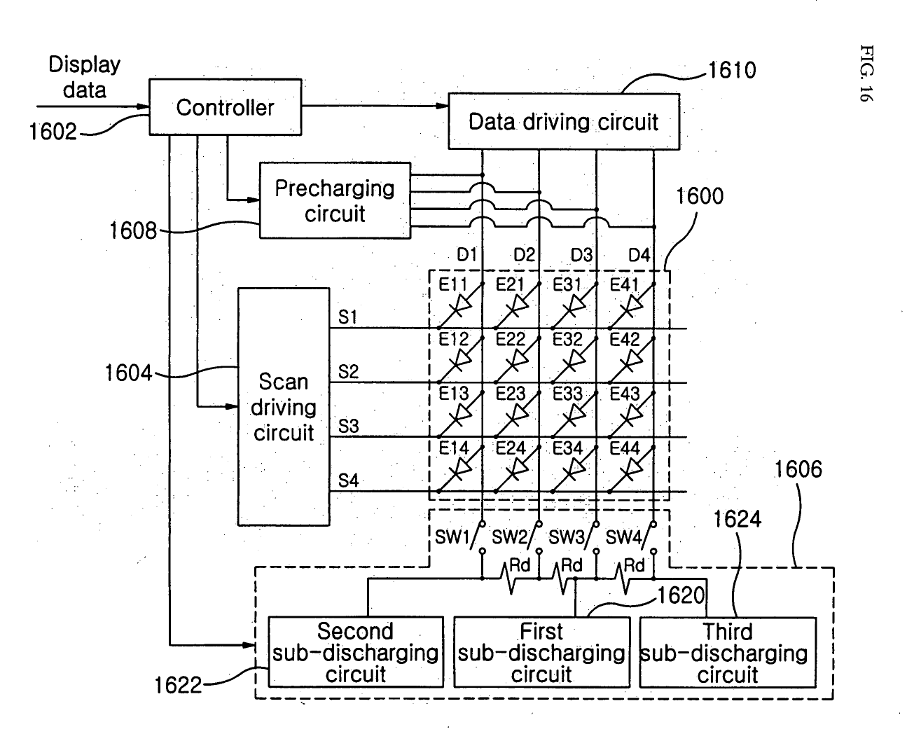

FIG. 16 is a view illustrating a light emitting device according to a tenth embodiment of the present invention.

In FIG. 16, the light emitting device of the present embodiment includes a panel 1600, a controller 1602, a scan driving circuit 1604, a precharging circuit 1608 and a data driving circuit 1610. Since the elements in the present embodiment except the scan driving circuit 1604 are the same as in the eighth embodiment, any further description concerning the same elements will be omitted.

In the light emitting device in the tenth embodiment, the scan driving circuit 1604 is formed in one direction of the panel 1600 unlike the eighth and ninth embodiments.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A light emitting device comprising:
data lines disposed in a first direction;
scan lines disposed in a second direction different from the first direction;
a plurality of pixels formed in cross areas of the data lines and the scan lines; and
a discharging circuit configured to discharge a first pixel of the pixels up to a first discharge voltage during a first discharge period of time, and discharge a second pixel of the pixels up to a second discharge voltage during a second discharge period of time,
wherein the second discharge voltage is different from the first discharge voltage.

2. The light emitting device of claim 1, wherein the discharging circuit configured to discharge at least one data line up to a discharge voltage corresponding to cathode voltage of pixel related to the data line and capacitance of a capacitor related to the pixel.

3. The light emitting device of claim 2, wherein the discharging circuit includes:
a first sub-discharging circuit coupled to a first outmost data line of outmost data lines of the data lines, and configured to provide a first voltage to the first outmost data line; and
a second sub-discharging circuit coupled to a second outmost data line of the outmost data lines, and configured to provide a second voltage to the second outmost data line.

4. The light emitting device of claim 3, wherein the discharging circuit further includes:
a third sub-discharging circuit coupled to one data line of data lines except the outmost data lines of the data lines, and configured to provide a third voltage to the data line.

5. The light emitting device of claim 4, wherein one or more of the sub-discharging circuit includes:
an OP amp; and
an digital-analog converter (DAC) coupled to an input terminal of the OP amp,
wherein an output terminal of the OP amp is coupled to data line related to the OP amp.

6. The light emitting device of claim 3, wherein the second voltage has magnitude different from the first voltage.

7. The light emitting device of claim 1, wherein the discharging circuit includes:
a first sub-discharging circuit configured to discharge the data lines to a first discharge voltage;
a second sub-discharging circuit coupled to a first outmost data line of outmost data lines of the data lines, and configured to provide a first voltage to the first outmost data line; and
a third sub-discharging circuit coupled to a second outmost data line of the outmost data lines, and configured to provide a second voltage to the second outmost data line.

8. The light emitting device of claim 7, wherein the first sub-discharging circuit includes:
a zener diode coupled to the data lines,
at least one of the second and third sub-discharging circuits includes:
an OP amp, wherein an output terminal of the OP amp is coupled to data line related to the OP amp; and
an digital-analog converter (DAC) coupled to an input terminal of the OP amp.

9. The light emitting device of claim 7, wherein the second voltage has magnitude different from the first voltage.

10. The light emitting device of claim 1, wherein an anode voltage of the first pixel reaches a first saturation voltage during a first luminescent period of time, and an anode voltage of the second pixel reaches a second saturation voltage during a second luminescent period of time,
wherein a difference of the first and second saturation voltages is substantially the same as a difference of the first and second discharge voltages.

11. The light emitting device of claim 1, wherein a difference of an cathode voltage of the first pixel and an cathode voltage of the second pixel is substantially the same as a difference of the first and second discharge voltages.

12. The light emitting device of claim 1, wherein the first discharge period of time is different from the second discharge period of time.

13. A light emitting device comprising.
data lines disposed in a first direction;
scan lines disposed in a second direction different from the first direction;
a plurality of pixels formed in cross areas of the data lines and the scan lines; and
a discharging circuit configured to have at least one discharge assisting device, and discharge at least one data line to a discharge voltage corresponding to cathode voltage of pixel related to the data line,
wherein the discharge assisting device facilitates the discharging.

14. The light emitting device of claim 13, wherein the discharging circuit includes:
a first sub-discharging circuit coupled to a first outmost data line of outmost data lines of the data lines, and configured to provide a first voltage to the first outmost data line; and
a second sub-discharging circuit coupled to a second outmost data line of the outmost data lines, and configured to provide a second voltage to the second outmost data line.

15. The light emitting device of claim 14, wherein the discharging circuit further includes:
a third sub-discharging circuit coupled to one data line of data lines except the outmost data lines of the data lines, and configured to provide a third voltage to the data line.

16. The light emitting device of claim 15, wherein one or more of the sub-discharging circuits includes:
an OP amp, wherein an output terminal of the OP amp is coupled to data line related to the OP amp; and
a digital-analog converter (DAC) coupled to an input terminal of the OP amp.

17. The light emitting device of claim 14, wherein the second voltage has magnitude different from the first voltage.

18. The light emitting device of claim 13, wherein the discharge assisting device is made up of OP amp.

19. The light emitting device of claim 13, wherein the discharge assisting devices are coupled to the data lines, respectively.

20. A light emitting device comprising:
data lines disposed in a first direction;
scan lines disposed in a second direction different from the first direction;
a plurality of pixels formed in cross areas of the data lines and the scan lines; and
a discharging circuit configured to discharge at least one data line to a first discharge voltage during a first sub-discharge time of a discharge time, and discharge the discharge data line to a second discharge voltage corresponding to cathode voltage of pixel related to the data line during a second sub-discharge time of the discharge time,
wherein the second sub-discharge time is changed depending on the magnitude of the second discharge voltage.

21. The light emitting device of claim 20, wherein the discharging circuit includes:
a first sub-discharging circuit configured to discharge the data lines to the first discharge voltage;
a second sub-discharging circuit coupled to a first outmost data line of outmost data lines of the data lines, and configured to provide a first voltage to the first outmost data line; and
a third sub-discharging circuit coupled to a second outmost data line of the outmost data lines, and configured to provide a second voltage to the second outmost data line.

22. The light emitting device of claim 21, wherein the first sub-discharging circuit includes:
a zener diode coupled to the data lines during the first sub-discharge time.

23. The light emitting device of claim 21, wherein at least one of the second and third sub-discharging circuits includes:
an OP amp, wherein an output terminal of the OP amp is coupled to data line related to the OP amp;
at least two resistors coupled in parallel to the OP amp; and
a digital-analog converter PAC) coupled to an input terminal of the OP amp.

24. The light emitting device of claim 23, wherein a resistor having lower resistance of the resistors is coupled to the OP amp when the second discharge voltage corresponds to high voltage, and a resistor having higher resistance of the resistors is coupled to the OP amp when the second discharge voltage corresponds to low voltage.

25. The light emitting device of claim 21, wherein the second voltage has magnitude different from the first voltage.

26. The light emitting device of claim 20, wherein the data lines are coupled to a ground during the first sub-discharge time.

27. A method of driving a light emitting device having a plurality of pixels formed in cross areas of data lines and scan lines, comprising:
providing a first voltage to a first outmost data line of outmost data lines of the data lines; and
providing a second voltage to a second outmost data line of the outmost data lines,
wherein at least one data line is discharged to a discharge voltage corresponding to a cathode voltage of pixel related to the data line and capacitance of a capacitor related to the pixel in accordance with the provided voltages.

28. A method of driving a light emitting device having a plurality of pixels formed in cross areas of data lines and scan lines, comprising:
discharging a first data line corresponding to a first pixel of the data lines during a first discharge time;
discharging a second data line corresponding to a second pixel of the data lines during a second discharge time;
providing a first data current to the discharged first data line; and
providing a second data current to the discharged second data line,
wherein difference of voltage at endpoint of the first discharge time in waveform of voltage which the first data line has and voltage at endpoint of the second discharge time in waveform of voltage which the second data has corresponds to difference of cathode voltages of the pixels and difference of capacitances of capacitors related to the pixels.

29. The method of claim 28, wherein the first pixel and the second pixel are disposed in the same scan line.

30. The method of claim 28, wherein the first pixel is disposed in a first scan line, and the second pixel is disposed in a second scan line next to the first scan line.

31. A method of driving a light emitting device having a plurality of pixels formed in cross areas of data lines and scan lines, comprising:
providing a first voltage to a first outmost data line of outmost data lines of the data lines; and
providing a second voltage to a second outmost data line of the outmost data lines,
wherein at least one data line is discharge to a discharge voltage corresponding to cathode voltage of pixel related to the data line, and the discharging is facilitated by discharge assisting device coupled to the data line.

32. A method of driving a light emitting device having a plurality of pixels formed in cross areas of data lines and scan lines, comprising:
discharging a first data line corresponding to a first pixel of the data lines during a first discharge time;
discharging a second data line corresponding to a second pixel of the data lines during a second discharge time;
providing a first data current to the discharged first data line; and
providing a second data current to the discharged second data line,
wherein difference of voltage at endpoint of the first discharge time in waveform of voltage which the first data line has and voltage at endpoint of the second discharge time in waveform of voltage which the second data has corresponds to difference of cathode voltages of the pixels, and the discharging is facilitated by discharge assisting device.

33. A method of driving a light emitting device having a plurality of pixels formed in cross areas of data lines and scan lines, comprising:
discharging at least one data line to a first discharge voltage during a first sub-discharge time of a discharge time; and
discharging the discharged data line to a second discharge voltage corresponding to cathode voltage of pixel related to the data line during a second sub-discharge time of the discharge time,
wherein the second sub-discharge time is changed depending on magnitude of the second discharge voltage.

34. A method of driving a light emitting device having a plurality of pixels formed in cross areas of data lines and scan lines, comprising:
discharging a first data line corresponding to a first pixel of the data lines and a second data line corresponding to a second pixel of the data lines to a first discharge voltage during a first sub-discharge time;
discharging the discharged first data line to a second discharge voltage during a second sub-discharge time; and
discharging the discharged second data line to a third discharge voltage during a third sub-discharge time,
wherein difference of voltage at endpoint of the second sub-discharge time in waveform of voltage which the first data line has and voltage at endpoint of the third sub-discharge time in waveform of voltage which the second data has corresponds to difference of cathode voltages of the pixels, and the second sub-discharge time is changed depending on magnitude of the second discharge voltage.

35. The method of claim 34, wherein the third sub-discharge time is changed depending on magnitude of the third discharge voltage.
